(19) United States
(12) Patent Application Publication
(10) Pub. No.: US 2021/0204493 A1
(43) Pub. Date: Jul. 8, 2021

(54) DRIP EMITTER FOR PERIODIC, VOLUMETRICALLY TIMED, IRRIGATION

(71) Applicant: TERRACUITY TECHNOLOGIES LTD., Tel Aviv (IL)

(72) Inventors: Moshe Lutzki, Kibbutz Gvat (IL); Meir Dagan, Kibbutz Gvat (IL); Nimrod Ari, Kokhav Yair (IL); Gill Rafael Tsouri, Rochester, NY (US)

(21) Appl. No.: 17/056,886

(22) PCT Filed: May 20, 2019
(86) PCT No.: PCT/IL2019/050567

§ 371 Date: Nov. 19, 2020

(30) Foreign Application Priority Data
May 21, 2018 (IL) 259501

(51) Int. Cl. A01G 25/02; A01G 25/16

(52) U.S. Cl. CPC A01G 25/023; A01G 25/165

(57) ABSTRACT

Drip emitter for periodic, volumetrically-timed, irrigation and drip irrigation laterals comprising such emitters, wherein the drip emitter implement a water-accumulation chamber as a hydro-mechanical timer and comprises in addition, a first no-drain valve positioned on the downstream side of the irrigation water inlet to the drip emitter, a second valve located on the downstream side of the irrigation water flow path in the drip emitter, and a water drain that connects to the flow of irrigation water from one side of an elastic member in the emitter's water-accumulation chamber to the second valve, in a manner that helps to close it.

### FIELD OF THE INVENTION

The various embodiments described herein generally relate to the drip irrigation field, and particularly drip emitters, which enable periodic, volumetric and timed irrigation of a predetermined quantity of water (“dose”) at the level of each discrete drip emitter.

### BACKGROUND OF THE INVENTION

Drip irrigation laterals are deployed over wide areas and are usually operated by valve control systems that are positioned at the very least at the head of the water feeding main conduit, (e.g. “feeding pipe”) which simultaneously feeds a plurality of drip irrigation laterals (the dividing line), or even at the head of each drip irrigation lateral equipped with multiple drip emitters along its length. Without being able to specifically control the irrigation time and volume of water (“dose”) flowing from each of the drip emitters in the array, at the level of each discrete drip emitter (as opposed to a whole array of drip irrigation laterals or a drip irrigation lateral with multiple drip emitters), it is necessary to have a plurality of control measures, the diameter of the pipe component in each of the laterals is relatively large and the laterals themselves are relatively short (to compensate for head losses).

Therefore, attempts were made to develop measures to periodically and volumetrically control the amount of water flowing from the discrete drip emitter, which are designed for integration at the single or discrete drip emitter level. Until the developments which the applicant of the present patent has introduced in the field, efforts were focused on trying to integrate remote control technologies using electromechanical actuators (e.g. fitting each drip emitter with a solenoid), which thereby requires electrical power sources and raises the costs of the drip emitters and makes them more susceptible to malfunctions.

The present Patent Applicant has already disclosed, inter alia, in International Patent Application No. WO2017/077527, a drip emitter where the water flow passage from it to the designated irrigation area can be independently, periodically closed by a hydro-mechanical mechanism. At the single discrete drip emitter level, the water flow passage from it to the designated irrigation area can be closed as a result of the continuous accumulation of water over time in a water-accumulation chamber that is formed in the drip emitter (and the independent reopening of the passage when water pressure in the pipe is reduced and the water-accumulation chamber empties of the water accumulated therein following the time previously needed to adequately accumulate water and pressure in the chamber to activate the closure of the passage).

Reference is made to FIG. 1, which schematically illustrates drip emitter 10, as persons skilled in the art may learn from the description provided there. Drip emitter 10 comprises water inlet 11, water outlet 12, irrigation water flow path 13, which is disposed between them and includes a pressure-reducing mechanism 13′ (e.g. in the form of a baffle labyrinth), which is configured to convert water flow entering the drip emitter under pressure (the water pressure in the pipe (which is not illustrated) to the drops flow from water outlet 12 to the designated irrigation area)). Drip emitter 10 is characterized by also being formed with water-accumulation chamber 14. The water-accumulation chamber is designed to act as a partition between the downstream side of pressure-reducing mechanism 13′ and outlet 12. In the illustrated configuration, water-accumulation chamber 14 is connected to also receive the flow of water from water inlet 11 (the flow of water splits so that concurrently and simultaneously with the flow of water to the irrigation water flow path 13, the flow of water is also routed to water-accumulation chamber 14). The aforesaid flow of water, from water inlet 11 to water-accumulation chamber 14 is through accumulatable water flow path 21 that is disposed between them. Accumulatable water flow path 21 also has pressure-reducing mechanism 21′ (e.g. in a baffle labyrinth configuration). Water-accumulation chamber 14 contains elastic member 23 (for example, a sort of inflatable water balloon). Elastic member 23 is installed in water-accumulation chamber 14, thereby separating between the flow of irrigation water and the flow of accumulatable water (i.e. the water-accumulation chamber is formed as two chambers—14′ and 14″, which are separated from each other by an elastic member 23). When water accumulates on one side of elastic member 23, which is directed towards accumulatable water flow path 21, the member is stressed for strain, the degree of which depends on the water pressure accumulating over time in water-accumulation chamber 14 (in chamber 14′). Depending on the characteristics of the member's behavior when exposed to strain, the elastic member bends towards water outlet 12 (in a movement within chamber 14″), in a way that eventually causes it to close (see the state of the elastic member as illustrated with broken lines). From the time water pressure in the pipe drops and chamber 14 empties of the water that has accumulated in it and has led—as previously stated, after enough time has passed for an adequate accumulation of water in the chamber to close water outlet 12, elastic member 23 is again not stressed for strain, and it reverts to its initial state.

Thus, a person skilled in the art will understand that the Patent Applicant's aforesaid publication teaches for the first time, at the structural level of the single discrete drip emitter, the integration of an autonomic hydro-mechanical mechanism, which acts as a sort of timer of the irrigation cycle from the drip emitter. This mechanism is based on the volume of water accumulating inside, which can also be likened to a sort of “capacitor” (water-accumulation chamber 14 with elastic member 23 fitted inside it). This “capacitor” is slowly “charged” with a flow of water to it through a designated “resistor” (pressure-reducing mechanism 21′), and is only “fully charged” after a certain period of time (during which the single drip emitter drips a “dose” of other water in the required quantity to the designated irrigation area), and achieves, from the time it fills up the water chamber in the time that has passed, the effect of independently closing the water outlet from the single drip emitter, and preventing a continued flow of water drops to the designated irrigation area.

Furthermore, a skilled person knows that the location of a drip emitter lateral for irrigating an area may expose the drip emitters installed along the lateral to varying water pressure (depending on their distance from the source of the water flow under pressure to the lateral (head losses) and depending on the topography of the surface on which the lateral is deployed). Given this basic principle, then in light of the Patent Applicant's aforementioned publication, a person skilled in the art understands that installing said lateral with drip emitters according to the publication may transfer the drip emitters along the lateral to a state of blocking the flow of water from them sequentially over time (along a timeline). In this way, a lateral in which drip emitters according to the publication are installed may produce a sort of “wave” phenomenon, one wave or more, of local irrigation along the lateral until the full irrigation cycle is completed along the full length of the lateral. Depending on the topography of the area where the lateral is positioned (and its effects on the water pressures and their location along the lateral), local irrigations (a number of “waves”) will be created until irrigation is completed from all the drip emitters along the full length of the lateral, and even one single “wave” the front of which may progress with time in a rather fixed and continuous direction along the lateral, might be created if the lateral is positioned on a predominantly flat area or one that is upwardly inclined in an essentially uniform angle.

In other words, in light of the aforesaid publication of the present Patent Applicant, a person skilled in the art also understands that installing a drip irrigation lateral, as said, with drip emitters according to the publication, will produce a drip irrigation lateral in which all the emitters along it will produce the same predetermined quantity of water before closing, and all will close at the end of the cycle. At the same time, in a lateral installed with drip emitters according to the publication, not all the drip emitters along the lateral will simultaneously irrigate in a manner that enables reducing the diameter of the pipe, lengthening the lateral, and reducing the need for control means to the lateral.

Furthermore, a person skilled in the art will understand that the Patent Applicant's aforesaid publication provided a teaching on the possibility of integrating the “capacitor” mechanism or the hydro-mechanical timer in the various types of drip emitters—in integral (“in-line”) drip emitters (single drip emitters mounted inside the pipe and affixed to its inner wall); on-line inserted drip emitters (single drip emitters that are connected outside the exterior wall of the pipe); and interconnected drip emitters like a sort of continuous “strip” of drip emitters.

The present Patent Applicant continued to disclose in Patent Application IL 249153 (which at the time of the present Application had not been published) an improvement over the drip emitter that was disclosed in the said publication WO 2017/077527. In Patent Application IL 249153 the present Patent Applicant discloses the installation of a valve on the downstream side of the pressure-reducing mechanism of the irrigation water flow path in the drip emitter (located before the water-accumulation chamber, which as stated separates between the downstream side of the pressure-reducing mechanism and the drip emitter outlet). a valve, which is adjusted to enable the flow of irrigation water drops into the water-accumulation chamber (on their way to the drip emitter outlet), as long as the water pressure differential between the valve inlet and the valve outlet is not less than its predetermined operational pressure differential, in a way that stabilizes the closure of the flow of water from the drip emitter to the designated irrigation area. In other words, according to the metaphor previously used, the valve serves as a sort of “diode” in a drip emitter that implements the “capacitor” mechanism or the hydro-mechanical timer.

Reference is made to FIG. 2, which is a schematic illustration of drip irrigation emitter 210, as skilled persons may learn about from the anticipated publication of the aforesaid Patent Application. Once the elastic member bends towards the water outlet from the drip emitter and causes it to close (as illustrated in broken lines), increasing pressure is exerted from the accumulation of irrigation water drops “trapped” inside chamber 18 of the water-accumulation chamber. In drip emitter 210, valve 17 will block the continued accumulation of irrigation water within chamber 18, whereby their pressure will remain lower than the pressure in the drip emitter inlet (the water pressure in the pipe). At the same time, as long as water continues to accumulate on one side of the elastic member and biases it to bend, then once valve 17 is activated it ensures that the pressure of the accumulating water in the water-accumulation chamber will be greater than the pressure of the accumulation of irrigation water drops “trapped” inside chamber 18 of the water-accumulation chamber on the other side of the elastic member, thereby stabilizing the closure of the drip emitter water outlet.

The anticipated publication of the aforementioned Patent Application will also point to the conventional possibility in the drip emitter field of installing a no-drain valve on the downstream side of the water inlet to the drip emitter. This can also be implemented in the drip emitter of WO 2017/077527 in addition to the obvious possibility of implementing not only the standard no-drain valve as an elastomeric diaphragm (or in other words as a single flexible diaphragm), but also the elastic member that is used according to WO 2017/077527 in such a configuration (and even the possibility of utilizing the same flexible diaphragm membrane itself—both as a no-drain valve (to designate one segment of it for this purpose), and as the elastic member in the water-accumulation chamber (to designate for this purpose a second and another segment), and even to apply the valve that is the subject of the aforementioned Application while utilizing the same unified elastomeric diaphragm (and designate a third segment of it for this purpose).

The present Patent Applicant has recently arrived at an improved design of a drip emitter that implements the “capacitor” mechanism or the hydro-mechanical timer, which as stated the Applicant was first to introduce in a way that enables economically manufacturing the drip emitter (despite having added the mechanism), and ensuring stable closure of the flow from the drip emitter and efficient discharge of the water accumulated inside it, from the time the flow is re-opened from it to the area designated for irrigation. This design is the subject of the present invention.

### SUMMARY OF THE INVENTION

Aspects and embodiment are directed to a drip emitter for periodic, volumetrically-timed irrigation, which comprises—
a water inlet to the drip emitter, a water outlet from the drip emitter, an irrigation water flow path, which is disposed between them and includes a first pressure-reducing mechanism, which is configured to convert water flow entering the drip emitter from the water inlet under pressure, to drops that drip from the water outlet, and
a water-accumulation chamber that is designed to separate between the downstream side of the pressure-reducing mechanism and the water outlet from the drip emitter, and is connected to intake of accumulatable water inside it, also from the water inlet, through an accumulatable water flow path, which includes a second pressure-reducing mechanism, and said water-accumulation chamber also contains an elastic member that separates and divides between the accumulatable water on its one side and the irrigation water on its other side, and
whereby once water accumulates on one side of the elastic member that is directed towards the accumulatable water flow path, the elastic member is stressed for strain which bends it towards the irrigation water outlet from the drip emitter, so that eventually the other side of the elastic member comes in contact with the water outlet from the drip emitter and causes it to close, and
wherein as the pressure of the water entering the drip emitter is reduced, the water-accumulation chamber empties of the water accumulated inside, the elastic member is again not stressed for strain, and it returns to its starting state while distancing its other side from the water outlet from the drip emitter and consequently opens it.

A drip emitter according to the invention is characterized in that it also comprises—
a. A first no-drain valve positioned on the downstream side of the irrigation water inlet to the drip emitter, before the irrigation water flow path and the accumulatable water flow path, and is connected to allow for a parallel flow of water towards them once the valve is opened, and to close by predetermined pressure; and
b. A second valve located on the downstream side of the pressure-reducing mechanism of the irrigation water flow path in the drip emitter, which is positioned before the water-accumulation chamber that separates between the downstream side of the first pressure-reducing mechanism and the water outlet from the drip emitter, and is connected once it is opened to the passage of irrigation water through the water-accumulation chamber, on the other side of the elastic member, to the water outlet from the drip emitter, and causes it to be close under predetermined pressure; and
c. A water drain that connects to the flow of irrigation water on the other side of the elastic member in the water-accumulation chamber to the second valve, in a manner that facilitates the second valve.

In another aspect, in a drip emitter in accordance with the invention, the second valve may open and allow the passage of irrigation water through the water-accumulation chamber, on the other side of the elastic member, to the water outlet from the drip emitter, but when the pressure of the irrigation water on the downstream side of the first pressure-reducing mechanism is lower than the predetermined water pressure that will cause the first no-drain valve to open.

In another aspect, in a drip emitter in accordance with the invention, the first pressure-reducing mechanism may be formed in such a way that it will provide less resistance to the irrigation water flow than the resistance provided by the second pressure-reducing mechanism to the accumulatable water flow, thereby ensuring a period of time for the outflow of water from the drip emitter to the designated irrigation area, before a volume of water accumulates in the water-accumulation chamber in a way that will lead to the closure of the water outlet from the drip emitter.

In another aspect ensuring an adequate period of time for the outflow of water from the drip emitter to the designated irrigation area, is provided by implementing the second pressure-reducing mechanism in the accumulatable water flow path, as a baffle labyrinth or a diaphragm based, pressure regulating shutter (throttling means for reducing the water flow rate) or a combination of both.

In another aspect, in a drip emitter in accordance with the invention the first no-drain valve comprises an elastomeric diaphragm, one side of which is exposed to the pressure of the water entering from the water inlet to the drip emitter, and the other side, which is not exposed to the water pressure entering the drip emitter through the water inlet, comprises an air draining means that exposes the other side of the diaphragm to atmospheric pressure.

In one configuration of a drip emitter according to the invention, the drip emitter is an integral drip emitter designed as a sort of rectangular prism and configured to be fixed to the inner wall of the water conduit, and when the drip emitter is also characterized in that it is a tri-part drip emitter consisting of a housing member, a cover member that is configured for installation inside the housing member, and an elastomeric member configured for installation while it is disposed between them.

The invention that is the subject of the Patent Application may also be embodied in a drip irrigation lateral consisting of a water conduit (e.g. pipe) along which are installed a plurality of drip emitters according to the invention (discrete integral “in-line” drip emitters, each of which is configured as a sort of rectangular prism or in the form of a cylinder; “on-line” inserted drip emitters; or a continuous line of drip emitters).

Still other aspects, embodiments, and advantages of these exemplary aspects and embodiment are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is, as stated, a schematic drawing of a drip emitter, as skilled persons learn from publication WO 2017/077527 of the Patent Applicant.

FIG. 2 is, as stated, a schematic drawing of a drip emitter, as skilled persons learn from IL 249153 of the Patent Applicant.

FIG. 3 is a schematic drawing of an example of a drip emitter according to the present invention.

FIGS. 4 and 5 are views in perspective (from different angles) of an example of a discrete integral drip emitter that implements the invention (according to the aspects schematically illustrated in FIG. 3).

FIGS. 6 and 7 are “exploded” views in perspective (from different angles) showing the parts of the drip emitter illustrated in FIGS. 4 and 5.

FIG. 8 is a side cross-section view of the drip emitter illustrated in FIGS. 4 and 5 (cross-section a-a in FIG. 12 below), wherein it is assembled but not yet incorporated (as an integral drip emitter) to the pipe of the drip irrigation lateral and attached to its inner wall.

FIGS. 9 and 10 are views in perspective of a discrete integral drip emitter that implements the invention, as an example of the drip emitter illustrated in FIGS. 4 and 5, but implements other means for connecting the cover member to its housing member, and a side-cross section of the drip emitter (cross-section a-a—in FIG. 9), which is assembled but not yet incorporated (as an integral drip emitter) to the pipe of the drip irrigation lateral and attached to its inner wall.

FIG. 11 is a schematic drawing of the discrete integral drip emitter illustrated in FIGS. 4 and 5, in a way that clarifies that its structure is consistent with the aspects of an example of any drip emitter in accordance with the invention, as illustrated in FIG. 3.

FIG. 12 is a top view of the exemplifying specific discrete integral drip emitter illustrated in FIGS. 4 and 5, wherein it is assembled and incorporated (as an integral drip emitter) in the pipe of the drip irrigation lateral and attached to its inner wall.

FIGS. 13-19 are a sequence of longitudinal cross-section views of the drip emitter illustrated in FIGS. 4 and 5 (cross-section b-b in FIG. 12), wherein it is assembled and incorporated (as an integral drip emitter) to the pipe of the drip irrigation lateral, attached to its inner wall, and wherein the drip emitter is illustrated in its various states of action.

FIG. 20 is a schematic drawing of another example of a drip emitter according to the present invention, wherein the second pressure-reducing mechanism in the accumulatable water flow path, is implemented as a combination of a baffle labyrinth and a diaphragm based, pressure regulating shutter (throttle means), in order to prolong the period of time during which the water-accumulation chamber of the drip emitter is filling up.

FIG. 21 is an “exploded” view in perspective showing the parts of a discrete, integral, tri-part drip emitter which is a version of the drip emitter in accordance with FIG. 20, wherein the cover member and the elastomeric member of the emitter are depicted from two sides (and therefore marked by the same numeral).

FIGS. 21a and 21b are partial cross sections of the drip emitter depicted in FIG. 21 showing its pressure regulating shutter (throttle means) in (respectively), rest and regulating stages.

FIG. 22 is a schematic drawing of drip emitter illustrated in FIG. 21, in a way that clarifies that its structure is consistent with the aspects of an example of any drip emitter in accordance with the invention, as illustrated in FIG. 20.

### DETAILED DESCRIPTION

It is to be appreciated that embodiments and apparatuses discussed herein are not limited in application to the details of construction and the arrangement of components set forth in the following description or illustrated in the accompanying drawings. The apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

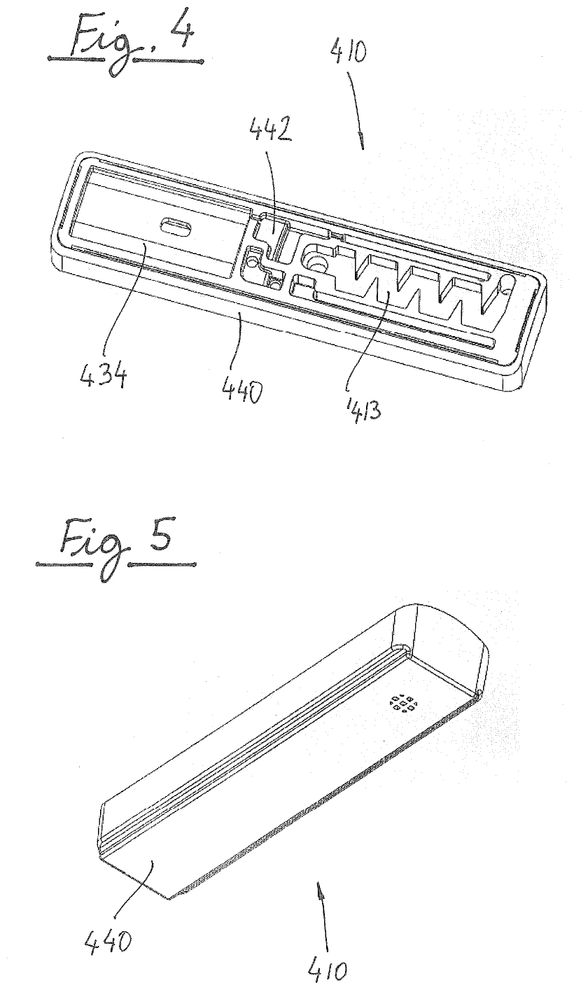

Reference is made to FIG. 3. FIG. 3 is a schematic drawing of an example of drip emitter 310 according to the invention.

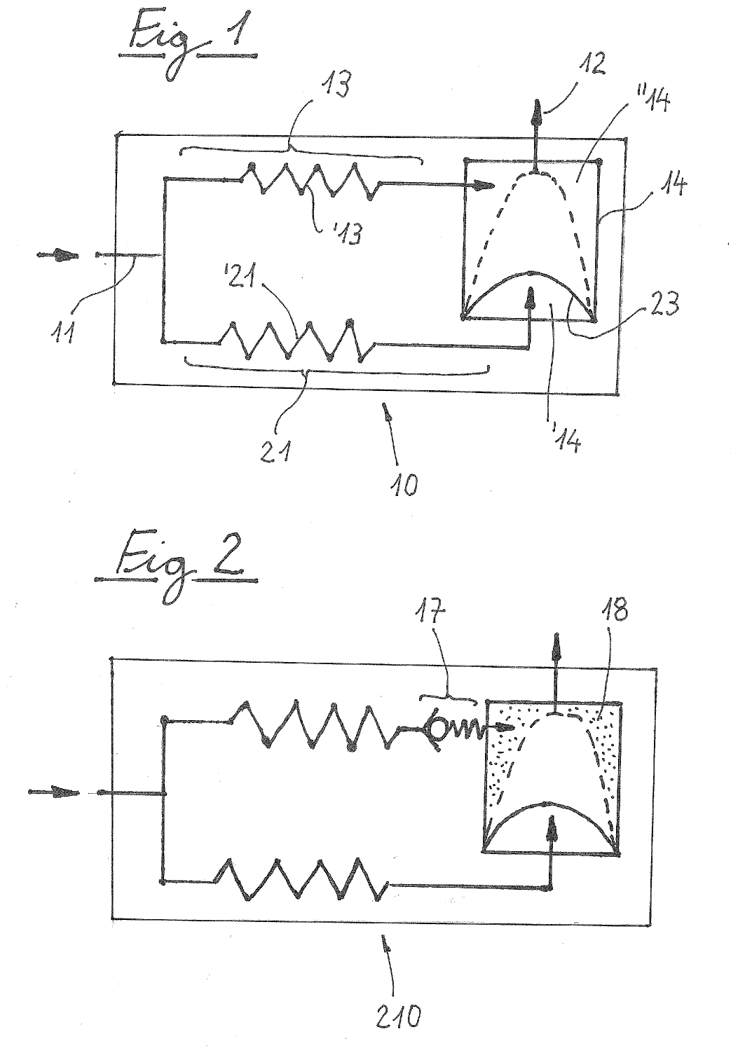

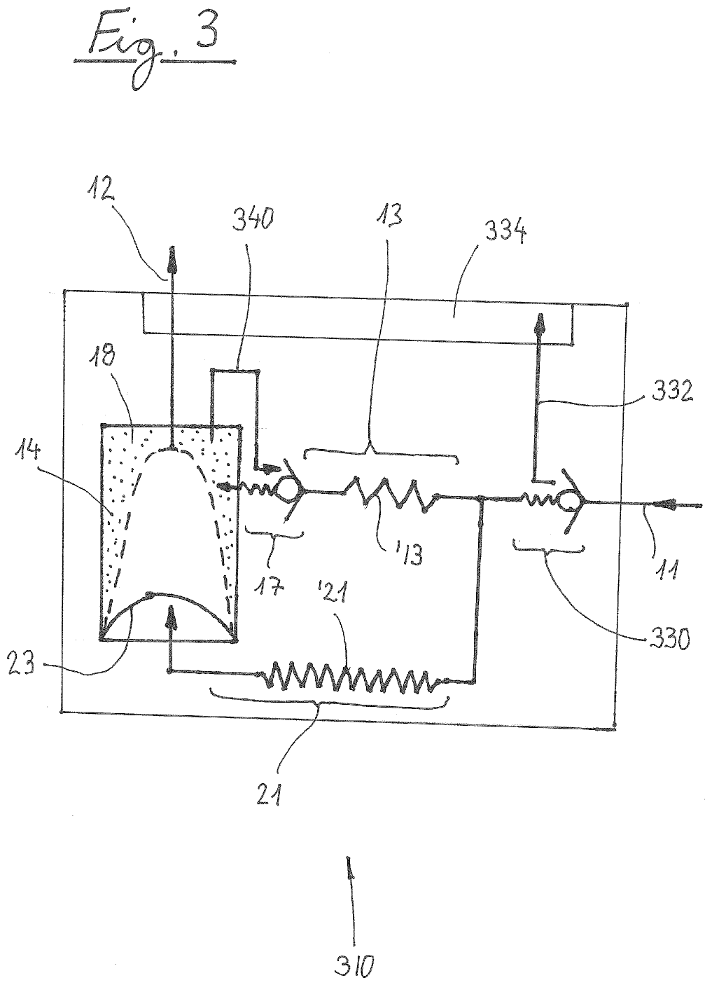

Similar to drip emitter 10 depicted in FIG. 1, drip emitter 310 also comprises water inlet 11, water outlet 12, and irrigation water flow path 13, which is disposed between them and includes a pressure-reducing mechanism 13′ (e.g. in the form of a baffle labyrinth), which is configured to convert water flow entering the drip emitter under pressure (the water pressure in the pipe (not illustrated) to the drip flow from water outlet 12 to the area designated for irrigation). Drip emitter 310 is also formed with water-accumulation chamber 14. The water-accumulation chamber is designed to act as a partition between the downstream side of pressure-reducing mechanism 13′ and water outlet 12. In the illustrated configuration, water-accumulation chamber 14 is connected to also receive the flow of water from water inlet 11 (the flow of water splits so that concurrently and simultaneously with the flow of water to the irrigation water flow path 13, the flow of water is also routed to accumulatable water flow chamber 14). The aforesaid flow of water, from water inlet 11 to water-accumulation flow chamber 14 is through accumulatable water flow path 21 that is disposed between them. Accumulatable water flow path 21 also has a pressure-reducing mechanism 21′ (e.g. in a baffle labyrinth configuration). Water-accumulation chamber 14 comprises elastic member 23 (for example, an elastomeric diaphragm or inflatable balloon). Elastic member 23 is installed in water-accumulation chamber 14 in a manner that separates and divides between the irrigation water flow and the accumulatable water flow. When water accumulates on one side of elastic member 23, which is directed towards accumulatable water flow path 21, the member is stressed for strain, the degree of which depends on the water pressure accumulating over time in water-accumulation chamber 14. Depending on the characteristics of the behavior of the member when exposed to strain, the elastic member bends towards water outlet 12 in a way that eventually causes it to close (see the state of the member as illustrated with broken lines).

Unlike drip emitter 10 illustrated in FIG. 1, drip emitter 310 is characterized in that it also comprises—
a. A first no-drain valve 330 which is located on the downstream side of the flow of water from water inlet 11.
   According to the illustrated example, no-drain valve 330 is the type that includes air draining means 332, which exposes the other side of the elastomeric diaphragm member normally installed in such a valve (the side not exposed to the water entering the drip emitter through the water inlet) to atmospheric pressure. According to the illustrated example, air drainage device 332 is connected to exit pool 334, which is formed in the drip emitter which the irrigation water drops also reach from the water outlet from the drip emitter, before they leave the drip emitter on their way to the designated irrigation area (in which there is therefore atmospheric pressure). Skilled persons are guided to learn about this type of no-drain valve from the publication of International Application WO 2007/046104.
b. A second valve 17, which is positioned on the downstream side of pressure-reducing mechanism 13′ of irrigation water flow path 13 in the drip emitter (positioned before fluid-accumulation chamber 14 which, as stated, separates between the downstream side of the pressure-reducing mechanism and water outlet 12 from the drip emitter).
c. Water drain 340, which connects to the water flow between chamber 18 of fluid-accumulation chamber 14 and the other side of elastomeric diaphragm that is normally installed in a valve of the type of valve 17 (the side not exposed to water coming from pressure-reducing mechanism ′13 of irrigation water flow path 13 in the drip emitter).

In drip emitter 310, first no-drain valve 330 will open and enable the flow of water from the feeding pipe (that does not appear in the illustration) to the drip emitter when the water pressure in the pipe will be higher than a predetermined threshold, and will again close and prevent the water from exiting the drip emitter and flowing back to the pipe, when the water pressure in the pipe is lower than the predetermined threshold. Second valve 17 will open and enable the passage of irrigation water from the downstream side of pressure-reducing mechanism ′13 (where the water pressure has dropped due to their passage through it) to chamber 18 of the water-accumulation chamber, when the water pressure is lower than the predetermined threshold pressure, as stated, thereby causing no-drain valve 330 to open so that irrigation water can reach the designated irrigation area for a period of time before water flow passage 12 from the drip emitter will be closed.

Around the time the water flow passage from the drip emitter is closed, second valve 17 will again close and block the passage of irrigation water to chamber 18 assisted by the water pressure that has accumulated in the chamber (the passage of the water through water drain 340 facilitates its closure). In this way, when valve 17 is closed and the feeding of chamber 18 with additional irrigation water is discontinued, the irrigation water that has not managed to exit through the water flow passage from the drip emitter before it was closed and “trapped” in chamber 18, will help to stabilize the “locking” of the drip emitter.

Once the flow path from the drip emitter is reopened, the water “trapped” in chamber 18 will be routed to the designated irrigation area, as well as any water remaining in drip emitter 310 once the no-drain valve 330 is closed (due to the drop in water pressure in the feeding pipe (that is not illustrated)), (water that has accumulated in water-accumulation chamber 14 and water remaining in the irrigation water flow path 13 and accumulatable water flow path 21), will also be discharged from the drip emitter when the flow path from it is reopened and flows to the area designated for irrigation.

A person skilled in the art will understand that first no-drain valve 330 and second valve 17 are ‘normally closed’ types of valves that may normally achieve this state, each by implementing an elastic elastomeric member that is stretched taut from the start on the edge of the water flow passage to the valve (an elastomeric member which upon installation is already forced into a curved state on the protruding edge of the water flow passage). A person skilled in the art will therefore understand that ensuring the opening of no-drain valve 330 under pressure, which is higher than the pressure in which valve 17 is activated to open, may be achieved by a standard engineering design of each valve, which will take into account such aspects as the type of elastomer from which the member is made, the initial tautness of the elastomeric member (the curvature rate), thickness of the elastomeric member, the geometric distance between the place where the elastomeric member is harnessed to the edge of the water flow passage to the valve, and the dimensions of the water flow passages there.

In drip emitter 310, pressure-reducing mechanism 13′ of the irrigation water flow path may be designed in such a way that it will provide less resistance to the irrigation water flow than the resistance of pressure-reducing mechanism 21′ of the accumulatable water flow path, in order to ensure a duration of time for the outflow of water from the drip emitter to the designated irrigation area, even before a volume of water accumulates in the water-accumulation chamber that will lead to closing the water outlet from the drip emitter.

A person skilled in the art will understand that pressure-reducing mechanisms ′13 and ′21 may be implemented as baffle labyrinths. A person skilled in the art will therefore understand that ensuring that the resistance of the irrigation water pressure-reducing mechanism to the water flow is less than the resistance to the water flow provided by the accumulatable water pressure-reducing mechanism, can be achieved by a standard engineering design of each labyrinth, which will take into account such aspects as labyrinth length, baffle shape and dimension of the flow passages between them.

Moreover, any person skilled in the art will understand that the drip emitter according to FIG. 3 and the above explanations, which implements the “capacitor” mechanism or the hydro-mechanical timer, while ensuring the stable closure of the water flow passage out of the drip emitter and the efficient discharge of the water that has accumulated inside it, from the time the water flow passage from it is reopened, to the designated irrigation area, may be an integral drip emitter (an in-line discrete drip emitter that is mounted inside a water conduit (e.g. extruded pipe)) affixed to its inner wall); an on-line inserted drip emitter (discrete drip emitters that are connected from outside the exterior wall of the conduit); or one drip emitter from a sequence of similar drip emitters that are interconnected like a sort of continuous “strip” of drip emitters and spans the length of the water conduit.

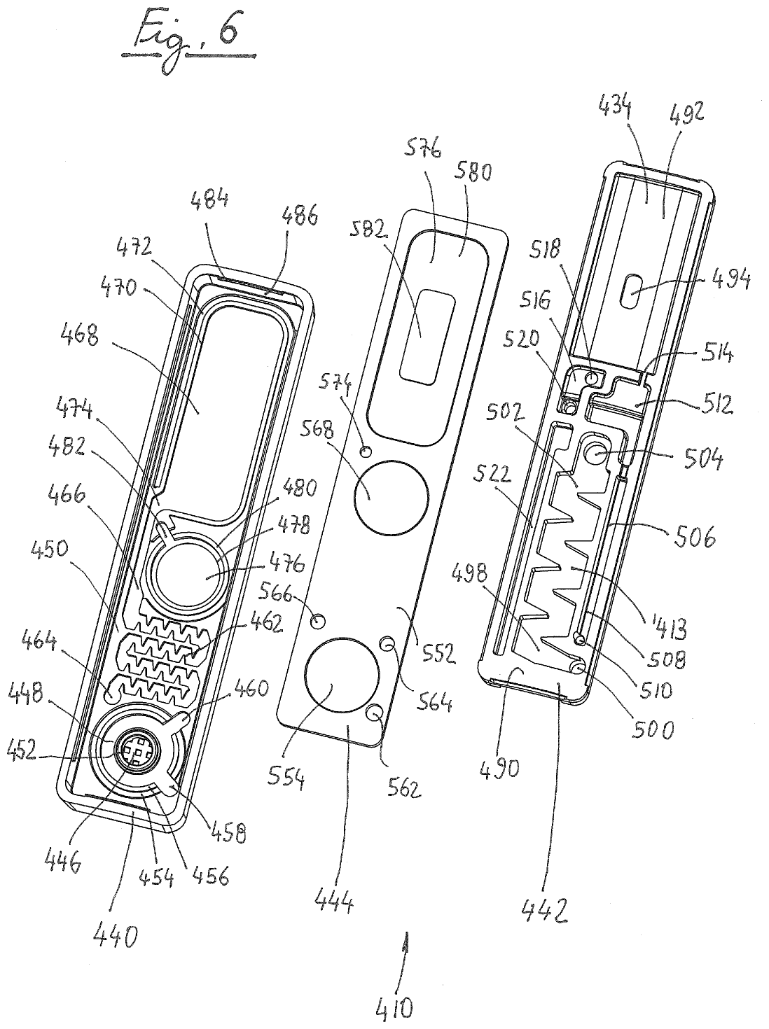

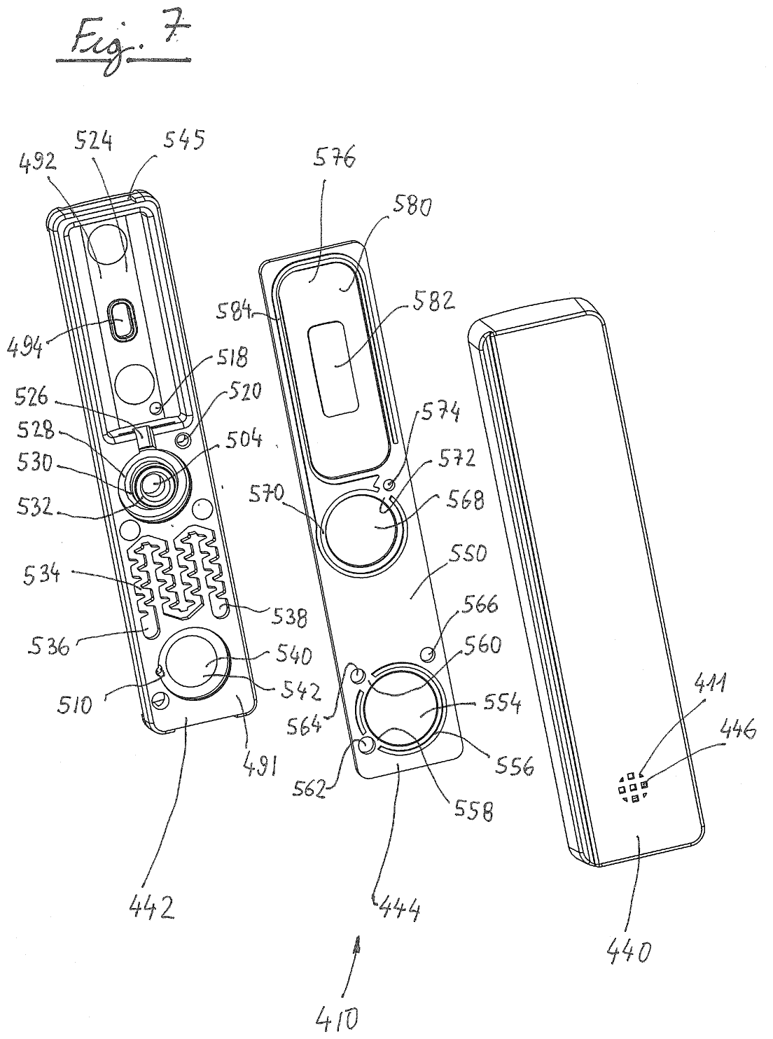

Taking the aforesaid into account and as an example only, a discrete integral drip emitter that implements the invention will be described below. Reference is made to FIGS. 4 and 5. FIGS. 4 and 5 are views in perspective (from different angles) of an example of discrete integral drip emitter 410 that implements the invention (according to the aspects schematically illustrated in FIG. 3).

From the outset, these drawings provide enough information for a person skilled in the art to understand that integral drip emitter 410 is the type configured as a sort of “boat”—as a rectangular prism unit, a configuration that in itself is familiar in the field. However, any skilled person will understand that an integral drip emitter according to the invention can also be designed in the form of a cylinder (a form that is also familiar in the field). Furthermore, a skilled person will understand from these drawings that drip emitter 410 is a type of integral drip emitter, which utilizes the inner wall of the pipe to which it is affixed to demarcate not only the exit pool (see 434 there) (opposite the pool a segment of the pipe wall will be formed with an opening to channel the water drops to the designated irrigation area), but also demarcate the baffle labyrinth that is implemented in the drip emitter for reducing the irrigation water pressure (see ′413 there). But similarly, a person skilled in the art will understand that an integral drip emitter according to the invention may be formed in a way that the baffle labyrinth is built into it and does not use the inner wall of the pipe for demarcation.

Drip emitter 410 is a tri-part drip emitter, which is comprised of housing member 440 and cover member 442, which are mounted together with an elastomeric member inside and fitted between them (and accordingly is not visible in the above drawings). Any person skilled in the art will understand that the design of drip emitter in accordance with the invention having only three parts ensures lower manufacturing costs.

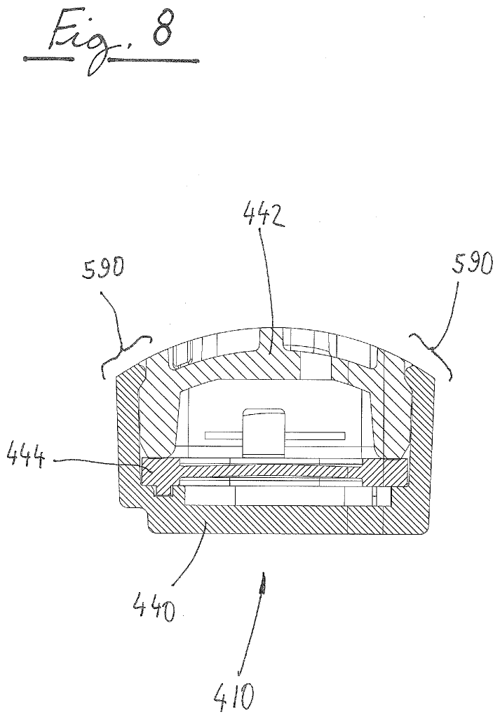

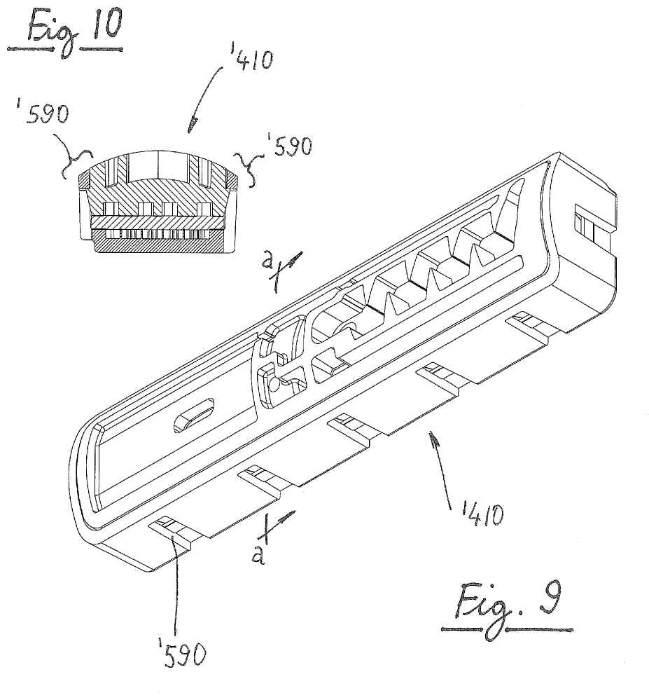

Reference is made to FIGS. 6 and 7. FIGS. 6 and 7 are exploded views in perspective (from different angles) of the members of drip emitter 410. As said, drip emitter 410 is a tri-part drip emitter comprised of housing member 440, cover member 442, and elastomeric member 444. A person skilled in the art will understand that housing member 440 and cover member 442 may be manufactured by injecting relatively rigid polymer material into molds (e.g. polyethylene). Elastomeric member 444 can be made of silicone rubber or thermoplastic elastomer (TPE).

Housing member 440 is shaped like a rectangular “box” that is open at the top. The bottom of the “box” is formed with water inlet 411, which in its illustrated embodiment is formed as filter 446, which is connected to the water flow filtered through it into stem 448 that protrudes over surface area 450 of the housing member (the surface of the bottom of the open “box” that forms the interior once the drip emitter members are fitted to each other). Stem 448 is formed with circumferential rim 452 at its edge, which protrudes from surface 450 (in such a way that forcing the elastomeric member against the rim prevents the passage of water from the stem, but separating the elastomeric member from the rim allows water to spill out of the stem). Circumferential protrusion 454 is formed around stem 448 and at a distance from it, and embedded channel 456 is formed around the protrusion. The protrusion and embedded channel array is formed wherein it is cut off at two passages 458 and 460 (in a way that affixing the elastomeric member against the protrusion and embedded channel array seals off the flow of water that spilled from the stem, and routes it to pass through the two passages 458 and 460). Surface area 450 of the housing member (which, as stated, forms the interior surface of the bottom of the open “box” when the drip emitter members are fitted to each other) is also formed with an embedded segment of baffle labyrinth 462, one end of which is 464 and the second end is 466. Second end 466 is formed as an embedded channel (in a way that affixing elastomeric member against the segment of the baffle labyrinth and streaming water to the first end will route the flow of water to the second end, while reducing the water pressure,). Surface area 450 is also formed with embedded chamber 468. The circumference of embedded chamber 468 is bound around circumferential protrusion 470 around which embedded channel 472 is formed. The protrusion and embedded channel array is formed wherein it is cut off at passage 474 (in a way that affixing elastomeric member against the protrusion and embedded channel array routes the flow of water coming from the second end of the baffle labyrinth, after the water pressure is reduced by it, to the embedded chamber). Housing member 440 is also formed with embedded chamber 476. The circumference of embedded chamber 476 is bound around circumferential protrusion 478 around which embedded channel 480 is formed. The protrusion and embedded channel array is formed wherein it is cut off at passage 482 (in a way that affixing elastomeric member against the protrusion and embedded channel array routes the flow of water coming from the passage to the embedded chamber). Housing member 440 is also formed with arrays of protruding edge 484 and dent 486 on the inside of each of the “box” walls (in a way that the arrays form a seating in snap-fit connectors that will be formed with a cover member to connect to the housing member while disposing the elastomeric member between them (we will elaborate on this when addressing FIGS. 8-10)).

Cover member 442 is formed as a rectangular prism and configured to be fitted inside box-like housing member 440. As previously noted, on the one side 490 of the cover member—the side which when the drip emitter is installed and incorporated in the pipe and affixed to the inner wall of the pipe—the cover member is formed with exit pool 434 and baffle labyrinth ′413, which is used in the drip emitter to reduce irrigation water pressure and are embedded in the member. Bottom 492 of exit pool 434 is formed as a wall at the center of which is opening 494 (in the illustrated example, an elongated opening) to allow for the passage of water from the opening into pool 434. Baffle labyrinth ′413 is formed at its one end 498 with opening 500, which is connected to the flow of irrigation water from the second side 491 of the cover member (see FIG. 7), and at second end 502 with opening 504 (in a way that upon affixing the drip emitter to the pipe wall and the influx of irrigation water through the opening at the one end into the baffle labyrinth, will route the flow of irrigation water coming from the second side of the cover member, in reducing the water pressure, to exit from the opening at the second end of the baffle labyrinth back to the second side of the cover member). The one side 490 of the cover member is also formed with embedded channel 506 (and terraced in the illustrated example), which runs along the cover member parallel to the baffle labyrinth. Embedded channel 506 is formed at its one end 508 with opening 510, which is connected to an air drainage coming from the second side 491 of the cover member, and at its second end 512 to passage 514 into the exit pool (in a way that upon affixing the drip emitter to the wall of the pipe and draining air from the other side of the cover member, through the opening at the one end, will route the air through the channel towards the opening at the second end, and from there the air will be drained into the exit pool). The one side 490 of the cover member is additionally formed with chamber 516, which is formed with one opening 518, that is connected for irrigation water drainage coming from the second side 491 of cover member, and draining into the chamber, and with a second opening 520, which is connected to the drainage of the irrigation water from the chamber back to the second side of the cover member (in a way that upon affixing the drip emitter to the wall of the pipe and the water drainage from the second side of the cover member, through the one opening, will route the water through the chamber to the second opening, and from there will drain the water back to the second side of the cover member). Any person skilled in the art will understand that the configuration of embedded channel 506, chamber 516 and additional chamber 522, which is also formed to be embedded on one side of the cover member and runs parallel to the baffle labyrinth, is cost-cutting in terms of use of raw materials and efficient injection of the member (homogeneous flow and distribution of the melted polymeric material). On the second side 491 of the cover member, the member is formed with embedded chamber 524 that is demarcated by bottom 492. Embedded passage 526 connects the chamber to embedded ring-like chamber 529, which is formed at its side (in a way that upon affixing elastomeric member against the ring-like chamber, the passage and the chamber connected to it, routes irrigation water coming from the ring-like chamber through the passage and into the chamber). Ring-like chamber 528 is formed around stem 530, which protrudes on the second side of the cover member, where it is formed around opening 504. Stem 530 is formed with circumferential rim 532 at the protruding end of the stem that is protruding as said, from the second side of the member (in a way that upon forcing elastomeric member against the rim prevents the passage of water from the stem, but separating the elastomeric member from the rim allows water to spill out of the stem). The second side of the cover member is also formed with an embedded segment of baffle labyrinth 534, one end of which is 536 and the second end is 538 (in a way that upon affixing elastomeric member flush with the labyrinth segment and streaming water to the first end, will route the flow of water, while reducing the pressure of the water, to the second end). The second side of the cover member is also formed with embedded chamber 540, which is demarcated by bottom wall 542, having formed with opening 510 for air drainage. Cover member 442 is additionally formed with arrays of steps 545 in each of the exterior walls of the cover member (whereby the arrays form the inserted part to the seating in the snap-fit connections, which will be formed with the housing member to connect with the housing member while disposing the elastomeric member between them (to be elaborated further on in addressing FIGS. 8-10)).

Elastomeric member 444 is formed as a rectangular flat surface that is configured for installation inside box-like housing member 440, wherein it separates between housing member 440 and cover member 442. Elastomeric member 444 is formed with one side 550, which upon assembling the drip emitter members to each other, is positioned against interior surfaces 450 of the bottom of the boxlike housing member, and with a second side 552 that is positioned against second side 491 of the cover member. The one side 550 of the elastomeric member (see FIG. 7) is formed with first segment 554 in a round configuration (in a way that upon assembling the drip emitter, the first segment is stretched taut (curvature) against circumferential rim 452). Circumferential protrusion 556 is formed around first segment 554 and at a distance from it (in a way that upon assembling the drip emitter, it is configured in size to fit into embedded channel 456 in order to fasten (“harness”) the first segment, as required in order for it to operate as an elastomeric diaphragm). The circumferential protrusion is formed wherein it is cut off at two passages 558 and 560, at the continuation of which are two openings (respectively)—562 and 564, which connect for water flow from one side of the elastomeric member to the second side (in a way that upon assembling the drip emitter, opening 562 will be positioned opposite opening 500, and opening 564 will be opposite one end 536). Formed at a distance from the circumferential protrusion, opening 566 also connects to the water flow from the second side of the elastomeric member to the first side (in a way that upon assembling the drip emitter, opening 566 will be positioned opposite second end 538 of the cover member and one end 464 of the housing member). The one side of the elastomeric member is also formed with second segment 568 that is round in shape (in a way that upon assembling the drip emitter, the second segment is stretched taut (curvature) against circumferential rim 532). Circumferential protrusion 568 is formed around second segment 568 and at a distance from it (in a way that upon assembling the drip emitter, it is configured in size to fit into embedded channel 480 in order to harness (fasten) the second segment, as required in order for it to function as an elastomeric diaphragm). The circumferential protrusion is formed wherein it is cut off at passage 572 at the continuation of which opening 574 is formed. Opening 574 connects to the water flow passage from the second side of the elastomeric member to the first side (in a way that upon assembling the drip emitter, opening 574 will be positioned opposite opening 520 of cover member 442 and passage 482 of the housing member). The one side of the elastomeric member is also formed with rectangular-shaped third segment 576. According to the illustrated example, third segment 576 is formed as wall 580, which is rather thin relative to the thickness of the elastomeric member. Wall 580 is formed at the center with rectangular segment 582, which increases its thickness on both sides (in a way that upon assembling the drip emitter, the third segment will be positioned opposite embedded chamber 524 and the rectangular thickened segment will be opposite opening 494). Circumferential protrusion 584 is formed around third segment 576 (in a way that upon assembling the drip emitter, it is configured in size to fit into embedded channel 472 in order to harness (fasten) the third segment, as required in order for it to function as an elastomeric diaphragm). Elastomeric member 444 is formed on its second side 552 with openings 562, 564, 566 and 574, which were indicated above (as through flow openings passing through the member) and with first segment 554, second segment 568 and third segment 576.

Once the drip emitter is assembled and operated, as to be explained below, each of the segments—first segment 554, second segment 568 and third segment 576 by itself—is an elastomeric diaphragm surface that is susceptible to bending forces, as a surface the circumference of which is harnessed (fastened). An elastomeric diaphragm surface, whose dynamic behavior characteristics under strain can be routinely engineered, taking into account such aspects as the type of the elastomeric material from which the member is made, initial tautness of the segment (its degree of curvature), (insofar as the specific segment is under tension strain from the beginning, already when it is harnessed between the housing and the cover members), the thickness of the specific segment (the shape of its cross-section), the geometric distance between the place where the segment is harnessed to the area on which it is exposed to strain, and the dimensions of its surface exposed to stress.

A person of skill in the art will understand that the method of harnessing (fastening) each of the segments—first segment 554, second segment 568, and third segment 576 for operation—each as an elastomeric diaphragm that will be exposed to bending strain stress, as described above, is by combining matching protrusion and channel arrays which, as in the illustrated example, are formed in the elastomeric member and the housing member (but a skilled person will understand that to the same degree they can be formed in the elastomeric member and in the cover member), is just an example. The harnessing of each of the segments, as required for their operation as elastic diaphragms, can be achieved not only by the beaded type technique, which combines such matching arrays of protrusions and channels, but alternatively can be achieved by various other techniques, which are already known in the field of harnessing elastomeric diaphragms in valves, such as the flat flange technique, by applying pressure on the surface along the circumference of the elastomeric segment. (See, for example, Diacom Corp.'s publications on the variety of harnessing methods that can be implemented for harnessing an elastomeric diaphragm in valves.)

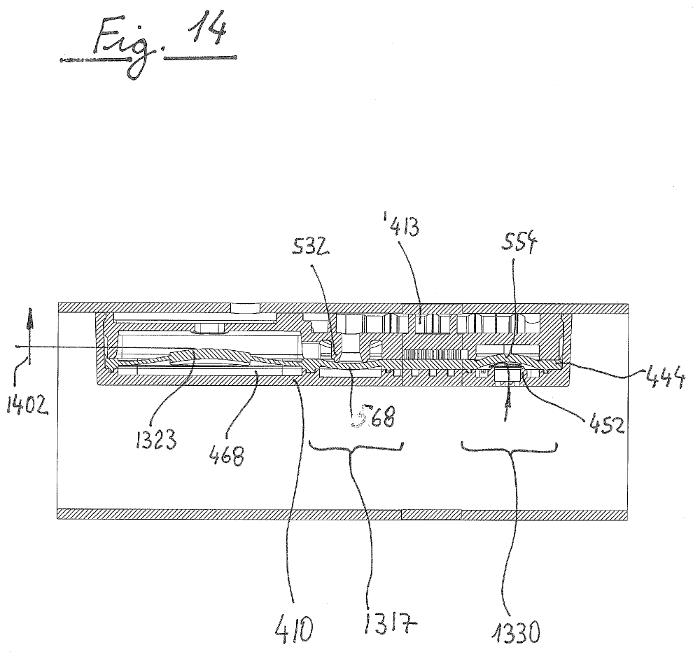

Reference is made to FIG. 8, which is a cross section side view of drip emitter 410 (cross-section a-a in FIG. 12), which is assembled but not yet incorporated (as an integral drip emitter) to the pipe of the drip irrigation lateral, and therefore it is not yet affixed to the inner wall of the pipe. In such a mounting stage, cover member 442 is fitted inside housing member 440, wherein elastomeric member 444 is slightly pinched between them (in a way that ensures that the various functional areas of the drip emitter are mutually sealed).

As may be seen in the illustrated example, the fitting of cover member 442 into housing member 440 is secured by connecting with snap-fit type connectors 590 that are formed between them.

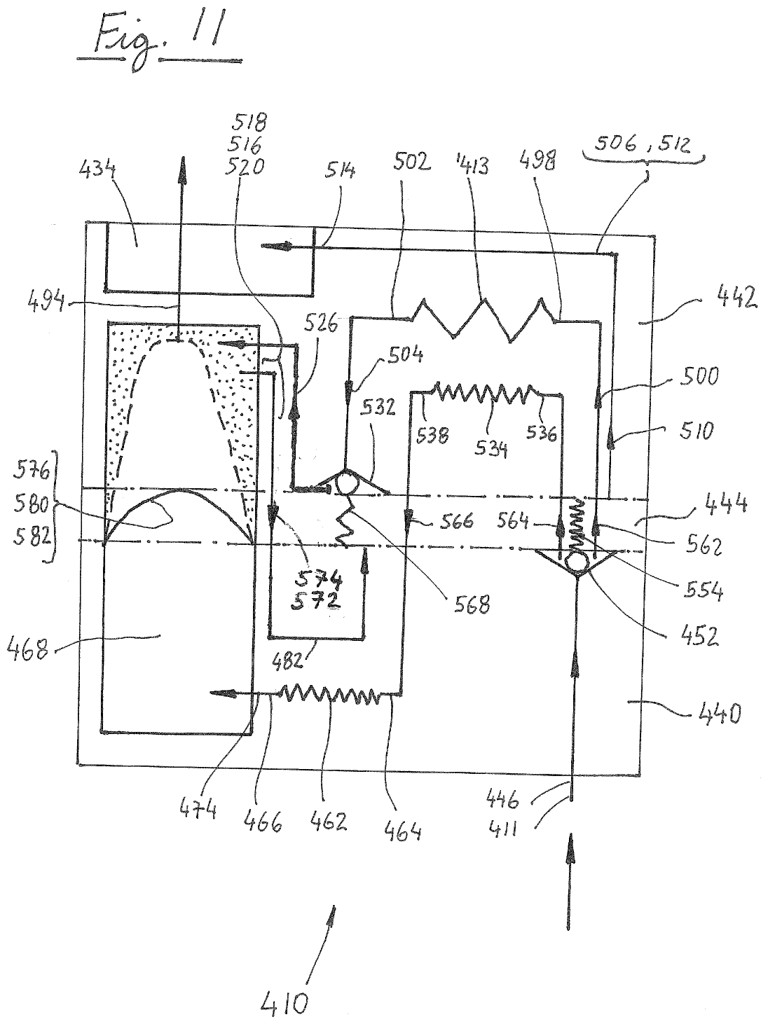

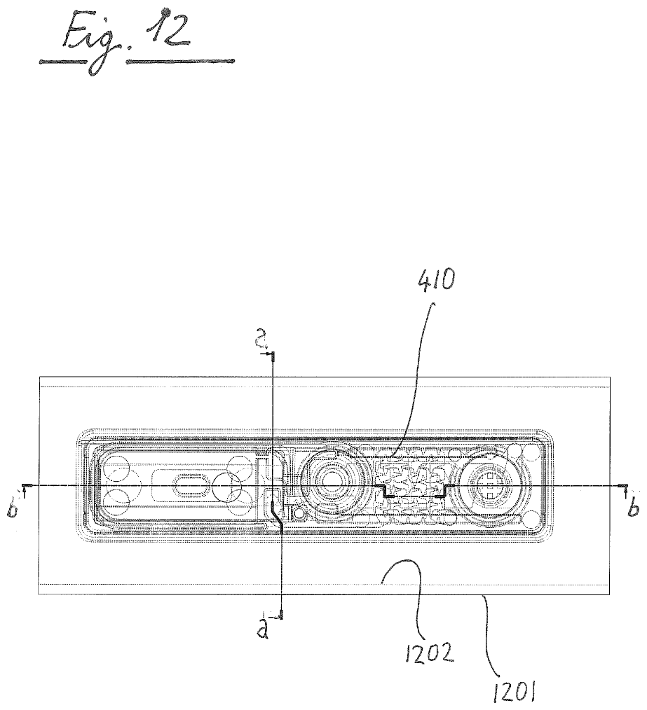

In the illustrated example and as described above, the connectors are extended consecutively along the interfaces between the members, but any skilled person would understand that this is just an example. For example, reference is made to FIGS. 9 and 10. FIGS. 9 and 10 are (respectively) a view in perspective of discrete integral drip emitter ′410 that implements the invention, such as drip emitter 410 illustrated in FIGS. 4 and 5, but it implements other means of connecting the cover member to its housing member, and a side cross-section of drip emitter ′410 (cross-section a-a—in FIG. 9), wherein it is assembled but not yet incorporated (as an integral drip emitter) to the pipe of the drip irrigation lateral and it is not yet attached to its inner wall. Snap-fit connectors 590 in drip emitter ′410 do not extend continuously along the interfaces between the members, but rather a plurality of connectors are implemented that are spaced apart.

Moreover, a person skilled in the art will understand that there are other means that may be implemented for connecting a cover member to a housing member in discrete integral drip emitters according to the invention. For example, designing one member with an array of pins (“rivets”) that are configured to fit into suitable seating in the other member; designing the members with an array of alternating dovetailed-shaped recesses and projections (see, for example, the embodiment of such an array in U.S. Pat. No. 6,027,048); designing the members with a press-fit connector between them; ultrasonically welding the members to each other; gluing the members together; designing the cover member as an integral unified part with the housing member by connecting them to each other with an integral hinge (and locking them after turning the members around the hinge and affixing them to each other by the aforesaid means) or combinations of these means.

Any person skilled in the art will also appreciate that securing the mounting of the housing and cover members in drip emitters 410 and ′410 by any of the aforesaid means is only required at the preliminary stages before affixing the drip emitters as integral drip emitters to the inner wall of the pipe, since in the aforesaid configuration of the drip emitters not only the cover member, but also the housing member is affixed at the end (e.g. by thermal welding) to the inner wall of the pipe (see FIGS. 8 and 10 where the housing members because of their box-like configuration, the “box” edges also form surfaces that stand to come in contact with the inner wall of the pipe (and not just the cover member that is incorporated inside)).

Furthermore, in light of FIGS. 8 and 10, any skilled person will also appreciate that in drip emitters 410 and ′410, the surfaces that stand to come in contact with the inner wall of the pipe are formed from the beginning in an arched configuration according to the expected arch of the pipe segment to which they will be attached (to also ensure proper fixation of the drip emitter that is mounted to the pipe wall.

Drip emitter 410 is a three-part manufacturing unit (housing member 440, cover member 442 and elastomeric member 444), but a skilled person will understand that the design of a drip emitter according to the invention, in a rectangular prism configuration (a “boat” drip emitter), can also be made as a two-part manufacture bi-component or a one-part manufacture bi-component, while possibly providing an additional savings in manufacturing costs. The elastomeric member may already be formed inside the injection mold, within a relatively rigid frame, which is connected to the edge of the housing member or to the edge of the cover member through a built-in integral hinge, and forms an integral and unified part with it. Thus, assembling them together (in one rotation against the other around the integral hinge) and mounting them after they are affixed to the other member (the housing member or the cover member) will form the drip emitter as a two-part manufacture bi-component (for an integral drip emitter in a rectangular prism configuration (“boat” drip emitter), which is a bi-component with an integral hinge (see publication WO 2012/137200 on page 16)).

Furthermore, as stated above, the design of a drip emitter in accordance with the invention, in a rectangular prism configuration (“boat” drip emitter), can also be made as a one-part manufacture bi-component drip emitter, wherein the rigid frame inside which the elastomeric member will be formed will be connected by one integral hinge to one edge of the housing member, and the cover member will be connected by a second integral hinge to another edge of the housing member, whereby all the required members will form an integral and unified part, and affixing them to each other (in a gradual rotation—one after the other, each around its own integral hinge, and accordingly affixed in overlapping each other) will form the drip emitter, as stated, as a one-part manufacture bi-component.

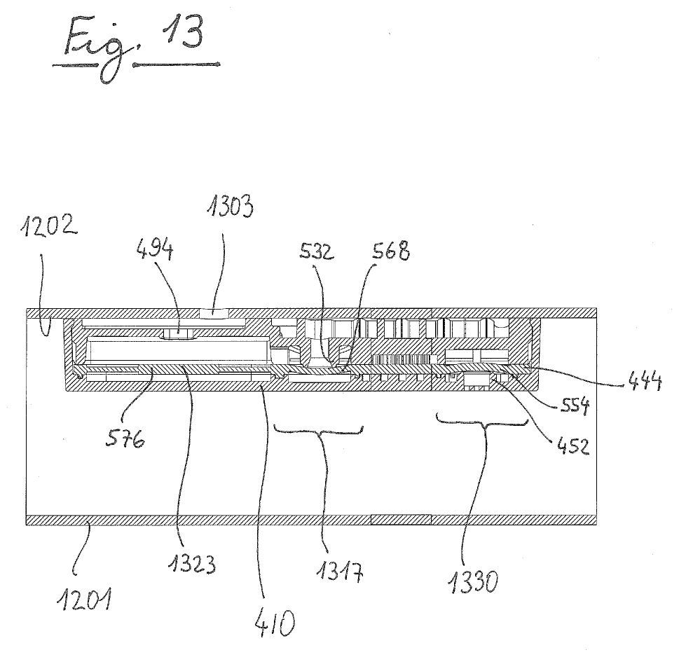

Reference is made to FIG. 11. FIG. 11 is a schematic diagram of the exemplifying specific discrete integral drip emitter 410, in a way that clarifies that its structure is consistent with the aspects of an example of any drip emitter in accordance with the invention, as illustrated in FIG. 3.

In light of the description and the above references to FIGS. 4-8, any skilled person will be able to deduce the specific components of drip emitter 410 upon mounting its three members—housing member 440, cover member 442 and elastomeric member 444 to each other, with the schematic drawing of an example of any drip emitter according to the invention, as illustrated in FIG. 3. Thus for example—

Like drip emitter 310 illustrated in FIG. 3, drip emitter 410 when assembled, as stated, also comprises a water inlet (filter 416 and water inlet 411), a water outlet (opening 494), and an irrigation water flow path, which is disposed between them and includes a pressure-reducing mechanism (baffle labyrinth ′413), which is configured to convert water flow entering drip emitter 410 under pressure (the water pressure in the pipe (not illustrated) to the drip flow from water outlet (opening 494) to the area designated for irrigation). Drip emitter 410 upon assembly, as stated, is also formed with a water-accumulation chamber (embedded chamber 468). The water-accumulation chamber is designed to act as a partition between the downstream side of pressure-reducing mechanism (′413) and water outlet (opening 494). Water-accumulation chamber (embedded chamber 468) is connected to also receive the flow of water from a water inlet (filter 416 and water inlet 411), (the flow of water splits so that concurrently and simultaneously with the flow of water to the irrigation water flow path, the flow of water is also routed to the accumulatable water flow chamber). The aforesaid flow of water, from the water inlet to water-accumulation flow chamber is through an accumulatable water flow path that is disposed between them. In addition, the accumulatable water flow path also consists of a pressure-reducing mechanism, which in drip emitter 410 upon mounting its three members to each other, embodies a serial configuration of a two-level baffle labyrinth (labyrinth segment 534 that is formed on the one level—in the cover member, and is connected in a column to the second level—to the housing member, where labyrinth segment 462 is formed). Water-accumulation chamber (embedded chamber 468) comprises an elastic member (third segment 576 in elastomeric member 444). The elastic member (third segment 576) is fitted in a water-accumulation chamber in a manner that separates and divides between the irrigation water flow path and the accumulatable water flow path. When water accumulates on one side of the elastic member (third segment 576) facing the accumulatable water flow path (the serial configuration of the two-level baffle labyrinth—labyrinth segments 534 and 462), the member is stressed for strain, the degree of which depends on the water pressure accumulating over time in the water-accumulation chamber (embedded chamber 468). Depending on the characteristics of the member's behavior (third segment 576) when exposed to strain, the elastic member (third segment 576) bends towards the water outlet (opening 494) in a way that eventually causes it to close (see the state of the member as illustrated with broken lines).

Like drip emitter 310 illustrated in FIG. 3, drip emitter 410 is characterized in that it also comprises—
a. A first no-drain valve (first segment 554 of elastomeric member 444 that is stressed for tension (curvature) against circumferential rim 452), which is located on the downstream side of the water flow from the water inlet (filter 416 and water inlet 411). Wherein the no-drain valve comprises an air draining means (in cover member 442 —opening 510 which is connected to embedded channel 506, which leads through passage 514 into exit pool 434 to which irrigation drops flow from irrigation water outlet 494 from the drip emitter, before they leave the drip emitter on their way to the designated irrigation area (in which there is therefore atmospheric pressure)), this exposes the second side of first segment 554 of elastomeric member 444 (the side not exposed to water entering drip emitter 410 through the water outlet) to atmospheric pressure.
b. A second valve (second segment 568 of elastomeric member 444 that is stressed for tension (curvature) against circumferential rim 532), which is positioned on the downstream side of the pressure-reducing mechanism (baffle labyrinth ′413) of the drip emitter's irrigation water flow path (located before water-accumulation chamber 468 which, as stated, divides between the downstream side of the pressure-reducing mechanism (baffle labyrinth ′413) and the water outlet from the drip emitter (opening 494)).
c. Water drain (in cover member 442—opening 518, chamber 516 and opening 520, in elastomeric member 444—opening 574, and in the housing member—passage 482), which is connected to the irrigation water that is “trapped” in the chamber (embedded chamber 524) of the water-accumulation chamber (chamber 468), once the drip emitter's water outlet is closed, thereby enabling the water to flow to the second side of the elastomeric diaphragm member (second segment 568 of elastomeric member 444), (the side not exposed to water coming from pressure-reducing mechanism ′413 of the irrigation water flow path in the drip emitter).

Reference is made to FIG. 12. FIG. 12 is a top view of drip emitter 410, when it is mounted and incorporated (as an integral drip emitter) in pipe 1201 of a lateral and affixed to its inner wall 1202 of the pipe.

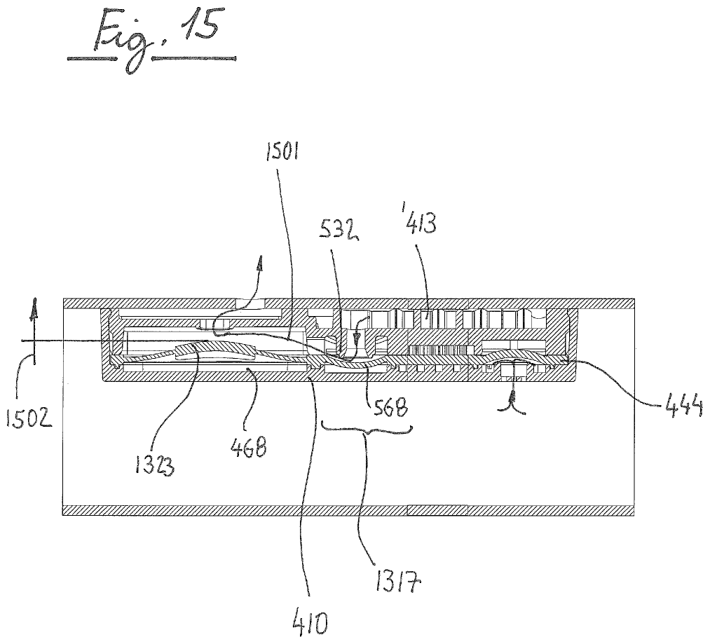

Reference is made to FIGS. 13-19. FIGS. 13-19 are a sequence of views of a longitudinal cross section (cross section b-b in FIG. 12) of drip emitter 410, when it is mounted and incorporated (as an integral drip emitter) in pipe 1201 of a lateral, affixed to inner wall 1202 of the pipe, wherein during the manufacturing process of the lateral, opening 1303 is formed in the pipe, opposite the exit pool of the drip emitter, to allow for water to exit from the drip emitter to the designated irrigation area (not illustrated), (e.g. the opening can be configured as a round hole or elongated slit). The sequence of drawings shows the drip emitter in its different modes of operation—

In FIG. 13, drip emitter 410 is at rest. In this state there is no flow of water from the pipe into the drip emitter. First no-drain valve 1330 (first segment 554 of elastomeric member 444 that is stressed for tension (curvature) against circumferential rim 452) is in a normally closed state and blocks water from entering the drip emitter. The second valve 1317 (second segment 568 of elastomeric member 444 that is stressed for tension (curvature) against circumferential rim 532) is also in a normally closed state. Elastic member 1323 (third segment 576 of elastomeric member 444) is in a resting state when distanced from the water outlet from the drip emitter (opening 494).

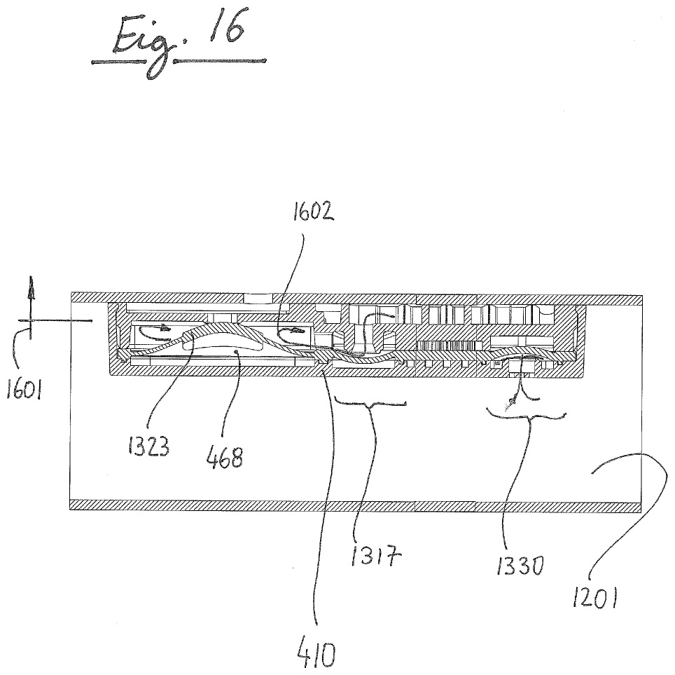

In FIG. 14, drip emitter 410 is exposed to water pressure inside the pipe, the rate of which causes the first no-drain valve 1330 to open (the water pressure stresses for strain first segment 554 of elastomeric member 444, which exceeds the initial stress of the segment against circumferential rim 452 and causes the segment to separate from the rim, thereby allowing water to enter the drip emitter (see arrow 1401)). The flow of water splits in the drip emitter so that concurrently and simultaneously with the flow of water to the irrigation water flow path, the flow of water is also routed to the accumulatable water flow chamber. At this stage, the reduced pressure of the irrigation water upon exiting the pressure-reducing mechanism (baffle labyrinth ′413) is insufficient to overcome second valve 1317, and it remains closed (second segment 568 of elastomeric member 444 is stressed for tension (curvature) against circumferential rim 532). At the same time, water passes in the accumulatable water flow path (through the serial configuration of the two-level baffle labyrinth) in order to accumulate in the water-accumulation chamber (embedded chamber 468), (in other words, in order to “charge the hydro-mechanical capacitor” or to start the timer), in a way that is likely to begin stressing elastic member 1323 to bend towards the water outlet from the drip emitter (in the direction of arrow 1402).

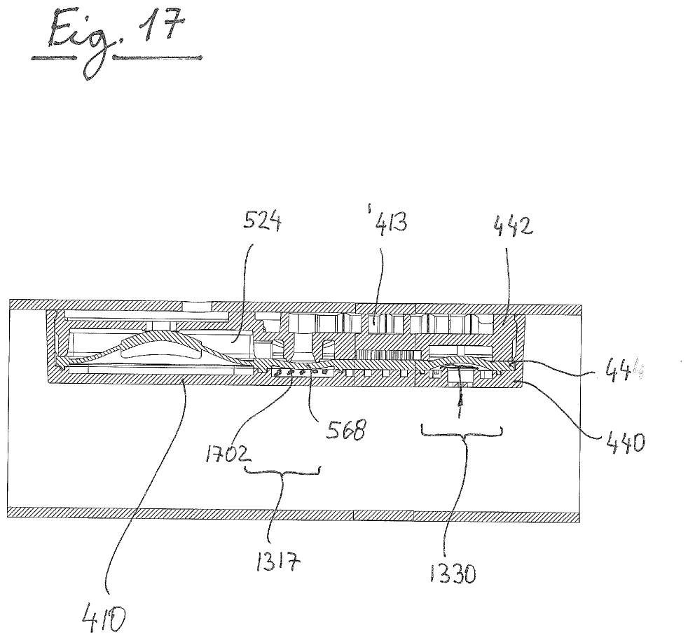

In FIG. 15, the drip emitter provides a flow of irrigation water to the designated irrigation area. The discharge of irrigation water from the drip emitter is enabled, as stated, at this point in time, since second valve 1317 submits to the pressure of the irrigation water upon exiting the pressure-reducing mechanism (baffle labyrinth ′413) and opens (the water pressure stresses for strain second segment 568 of elastomeric member 444, which exceeds the initial stress of the segment against circumferential rim 532 and causes the segment to separate from the rim in a way that allows for the outflow of water from the drip emitter (see arrow 1501)). At the same time, water accumulates in the water-accumulation chamber (embedded chamber 468), (in other words—the hydro-mechanical “capacitor” is “charged” or the timer is counting), in a way that stresses elastic member 1323 to bend towards the drip emitter water outlet (in the direction of arrow 1502). (After a period of time, the bending will later end this stage of the outflow of irrigation water from the drip emitter.)

In FIG. 16, drip emitter 410 closes (“locks”) after a period of time and stops emitting irrigation water. The water that accumulated in the water-accumulation chamber (embedded chamber 468) continues to stress elastic member 1323 to bend (in the direction of arrow 1601) until it causes the elastic member to come in contact with the water outlet from the drip emitter, after a period of time, and seals off the outflow of additional water towards the designated irrigation area. (In other words, the “capacitor is fully charged” or the time counter has reached the end of the process). The quantity of irrigation water (“dose”) that is streamed through the drip emitter until it “locks” (as illustrated), and the water pressure that continues to prevail in pipe 1201 (and leaves first no-drain valve 1330 and second valve 1317 open at this stage for the passage of water), without a discharge through drip emitter 410 that was “locked”, as stated, it is likely to travel to another place along the lateral in order to locally increase the pressure on another drip emitter (one or more), (which are not illustrated), whereby the volumetric flow rate of water in the pipe at that place becomes available for operating the other drip emitter (one or more), (which are not illustrated), for the outflow of water from it (see above regarding the “wave” phenomenon). At the same time, drip emitter 410 remains full of water—including the same irrigation water that is “trapped” inside on its way to the water outlet from the drip emitter that was blocked to said water (see arrow 1602).

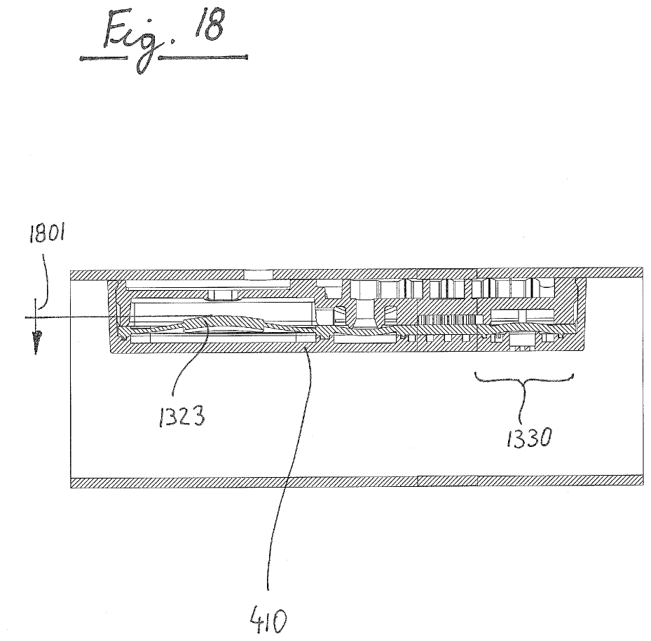

In FIG. 17, just after drip emitter 410 closes (as illustrated in FIG. 16), a water drain (in cover member 442—opening 518, chamber 516 and opening 520, in elastomeric member 444—opening 574, and in housing member 440—passage 482), which connects to the flow of water between embedded chamber 524 (which at this stage, after the closure of the water outlet from the drip emitter, the pressure of the “trapped” water in it rises), and the second side of segment 568 of elastomeric member 444 (the side not exposed to water coming from pressure-reducing mechanism ′413 of the irrigation water flow path in the drip emitter) (see arrow 1702), helps to close second valve 1317 (which, as stated, is designed so that its operating pressure is lower than the operating pressure of first no-drain valve 1330 and which accordingly remains open at this stage and continually feeds the water-accumulation chamber to ensure the stable “locking” of the drip emitter).

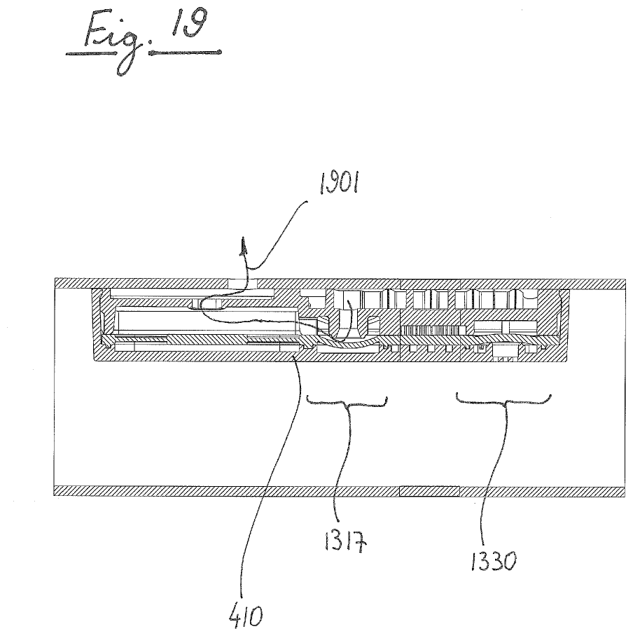

In FIG. 18, the water pressure in the pipe is reduced (for example, after completing the irrigation “wave” along the lateral). In this situation, first no-drain valve 1330 in drip emitter 410 returns to its closed state (and no longer feeds the water-accumulation chamber). The water accumulated in the water-accumulation chamber is pushed to retreat as elastic member 1323 aspires to return to its former state (in rest—not stressed for bending (as illustrated in FIG. 13), while moving in the direction of arrow 1801 (while re-opening the water outlet from the drip emitter), (in other words—the hydro-mechanical “capacitor” begins to “discharge”). The water retreating from the water-accumulation chamber (due to the action of elastic member 1323 on its way back to its normal rest state) is thus channeled backwards, under the pressure of returning elastic member 1323, through an accumulatable water flow path (through the serial configuration of the two-level baffle labyrinth) and into the chamber surrounding first no-drain valve 1330 (which is now closed).

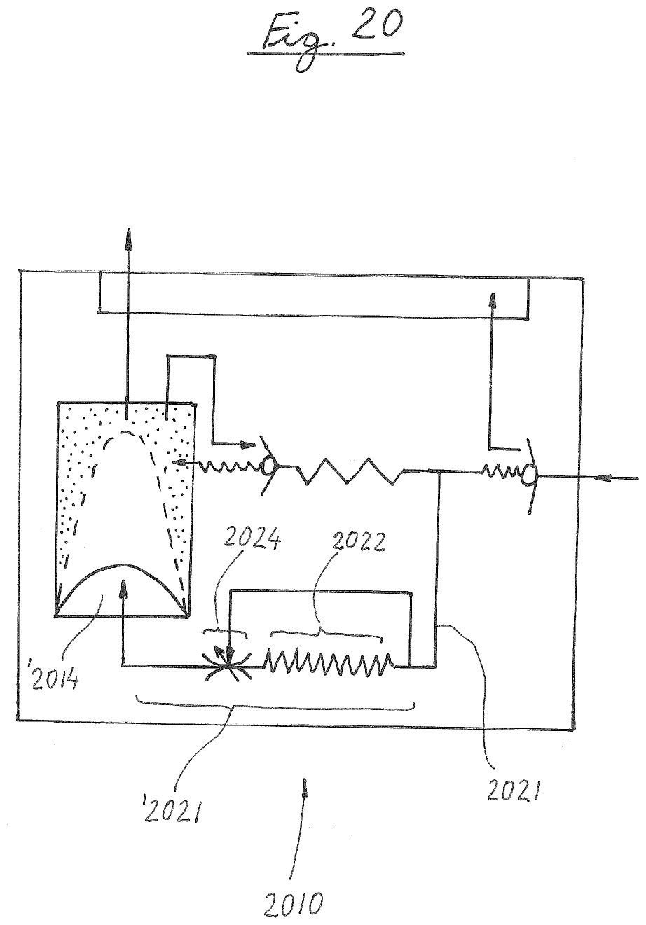

In FIG. 19, the accumulated water is pushed back (in the illustrated example—due to the pressing of elastic member 1323 while returning to its normal state), according to the illustrated example—at a time when it does not hold sufficient force to open first no-drain 1330 and return to the pipe. Therefore, the only outlet left open, according to the illustrated example, is the irrigation water flow path, in a way that could momentarily open second valve 1317 (whose operating pressure as said, is lower than that of the operating pressure of the first no-drain valve) and spurt out the remaining water left in the drip emitter to the designated irrigation area (see arrow 1901) (in other words, the hydro-mechanical “capacitor” is fully “discharged”).

Any skilled person will appreciate that the water that spurts out and empties the drip emitter of water remaining inside will also help to self-clean the water flow passages in the drip emitter, thus reducing the risk of the buildup of impurities and blockages.

At the same time, a person skilled in the art will also understand that in a scenario where contrary to what is described above and illustrated in FIG. 19, the remaining water does not spurt out to the designated irrigation area, then the water will remain in the drip emitter waiting for the next operating cycle of the drip emitter (unless the push-back pressure of the water accumulated in the water accumulation chamber is sufficient to cause the momentary opening of the first no-drain valve and the routing of the water back to the pipe).

Following this stage, the lateral in which drip emitter 410 is installed will be reactivated when the source of the water pressure to the pipe is closed and reopened. The drip emitter will “restart” to an additional timed work cycle when the water pressure builds up in the pipe at the location of the drip emitter at the entrance to its first no-drain valve, when it reaches the predetermined level.

In the examples described above while referring to the accompanying figures of drip emitters 310, 410 and ′410, ensuring an adequate period of time for the outflow of water from the drip emitter to the designated irrigation area, is provided by implementing the second pressure-reducing mechanism in the accumulatable water flow path, as a baffle labyrinth base mechanism per-se (′21 in emitter 10, 534 and 462 in emitters 410 and ′410). In light of the above, any person skilled in the art will understand, that in case the time period in which the water-accumulation chamber is filled up need to be prolonged (before closing the water outlet), for the purpose of providing a prolonged irrigation time and an enlarged water quantity to be dripped out of the emitter, while keeping the emitter design in a relatively small geometrical dimensions, a more efficient second pressure-reducing mechanism might be required.

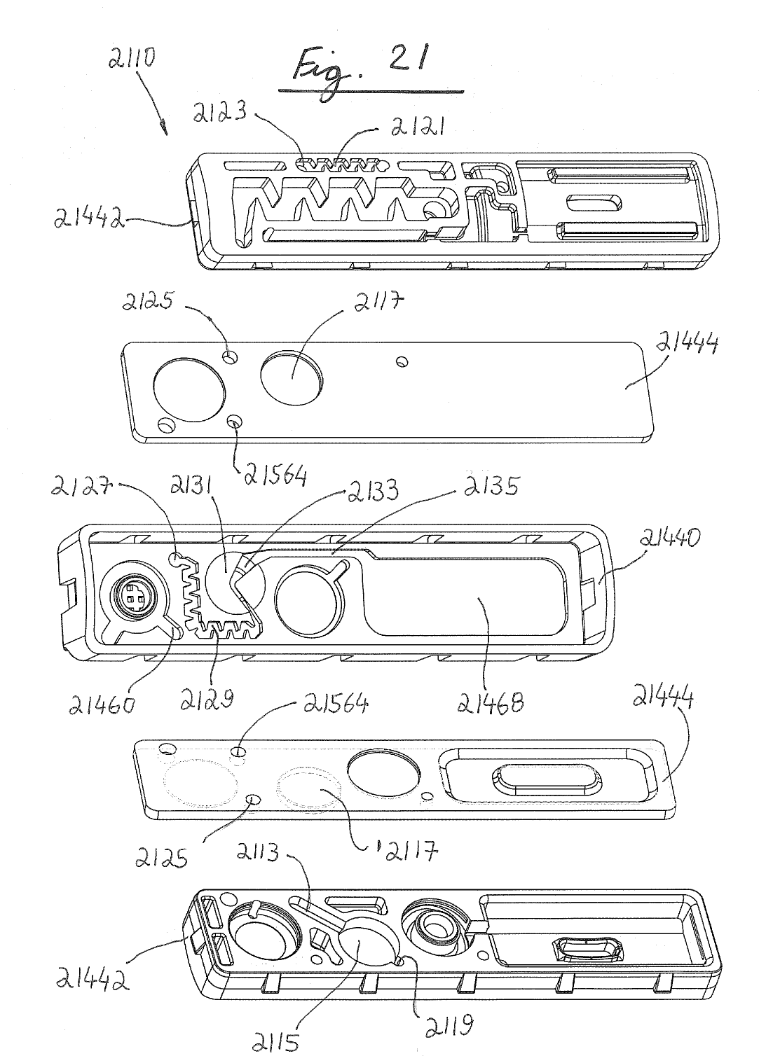

For example, reference is being made to FIG. 20. FIG. 20 is a schematic drawing of another example of a drip emitter 2010 according to the present invention, wherein the second pressure-reducing mechanism ′2021 in the accumulatable water flow path 2021, is implemented as a combination of baffle labyrinth 2022 and a pressure regulating shutter 2024, arranged in a row, in order to prolong the period of time during which the water-accumulation chamber ′2014 of drip emitter 2010 is filling up (in comparison to FIG. 3 depicting emitter 310).

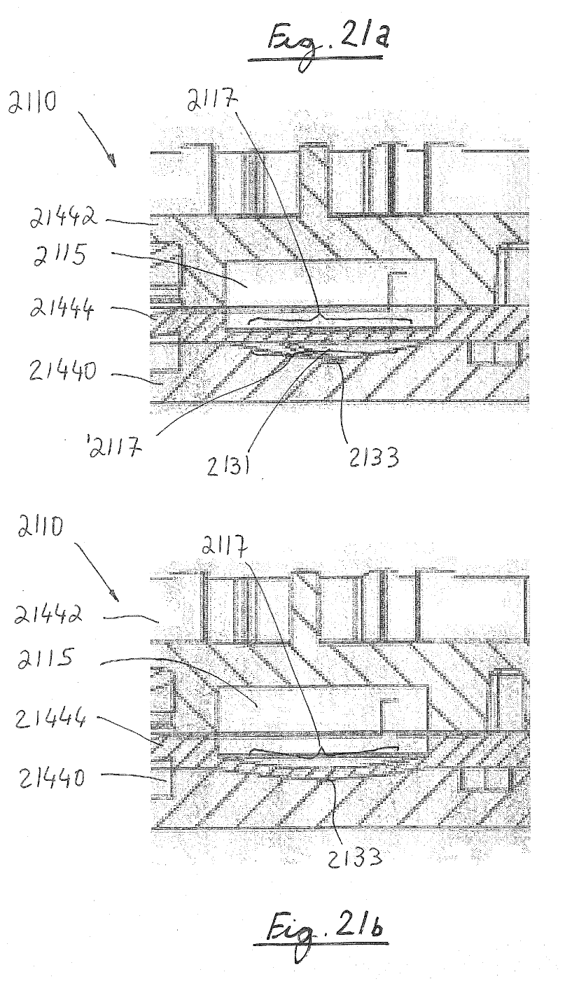

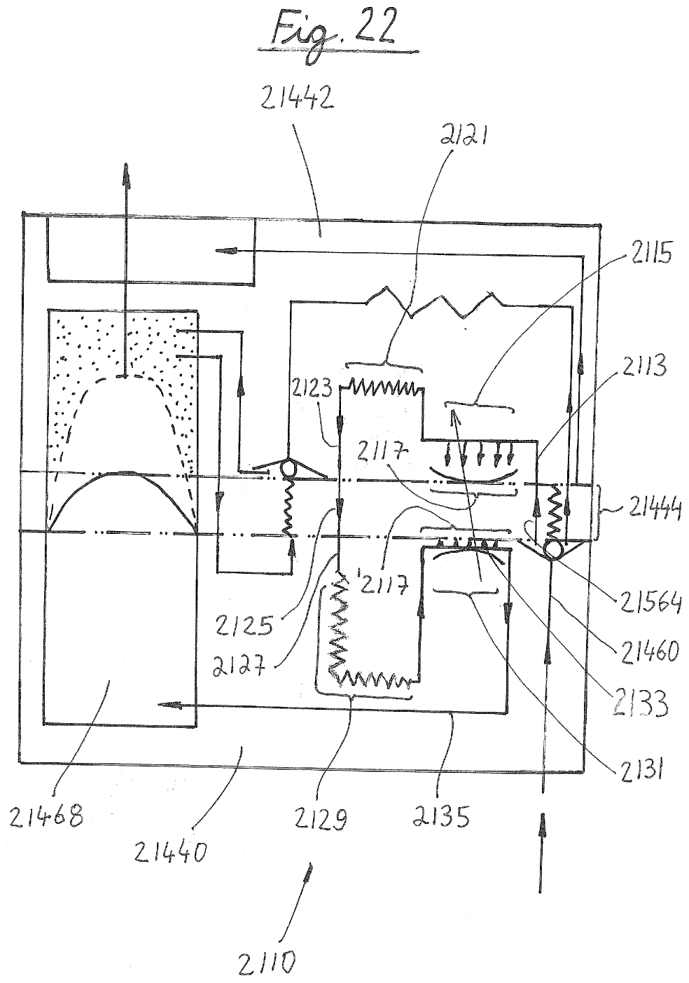

Reference is being made to FIGS. 21, 21a and 21b. FIG. 21 is an “exploded” view in perspective showing the parts of a discrete, integral, tri-part drip emitter 2110 which is a version of drip emitter 2010 in accordance with FIG. 20, wherein the cover member 21442 and the elastomeric member 21444 of the emitter are depicted from two sides (and therefore marked by the same numeral), in both sides of the emitter's housing member 21440. FIGS. 21a and 21b are partial cross sections of drip emitter 2110 showing its pressure regulating shutter (throttle means) in (respectively), rest and regulating stages.

At this stage and in light of our current purpose to describe an example of implementation of a more efficient second pressure-reducing mechanism in a tri-part integral drip emitter which is otherwise similar to drip emitters 410 and ′410 as described hereinabove while referring to FIGS. 4-19, we will emphasize on the exemplified second pressure-reducing mechanism while for convenience will not re-marking and describing the aspects, features (and their mode of operation) already learned by the skilled reader of this patent application.

In drip emitter 2110, water entering the emitter are routed through passage 21460 into opening 21564. From opening 21564 this relatively high pressure water are flowing through channel 2113 embedded in cover member 21442. Channel 2113 lead the water into cell 2115 that is also formed in the form of an embedded cavity in cover member 21442. Upon installation of the emitter's parts, cell 2115 will act as the upper cell of a pressure regulation mechanism (a throttling means for reducing the water flow rate), exposing a fourth segment 2117 of elastomeric member 21444 to a rather high pressure acting on one of its sides. In the illustrated example fourth segment 2117 is depicted as an embedded, circular shaped and rather thin segment of elastomeric member 21444. Upon assembling cover member 21442 inside housing member 21440, fourth segment 2117 is circumferentially harnessed in order to operate as an elastic diaphragm, in a way similar to the first, second and third segments of elastomeric member 21444 (their purpose and mode of operation described hereinabove while referring to emitter 410 and ′410).

The high pressure water that enter cell 2115 are flowing into opening 2119 and entering first labyrinth 2121. Upon passing through first labyrinth 2121 the then already reduced pressure water are routed through opening 2123, into opening 2125 that is formed in elastomeric member 21444 and into entrance 2127 of second labyrinth 2129 which is formed embedded in housing member 21440. The pressure of the already reduced pressure water that are passing through second labyrinth 2129 is therefore further reduced while reaching lower cell 2131 formed in housing member 21440. Lower cell 2131 is formed with an embedded slit 2133 (in the illustrated example, slit 2133 is depicted as conical expended shaped slit). Upon installation of the emitter parts, cell 2131 will act as a the lower cell of a pressure regulation mechanism (a throttling means for reducing the water flow rate), exposing fourth segment 2117 of elastomeric member 21444 to a rather low pressure acting on its second side (′2117) that is facing slit 2123 (while at the same time, as said, a rather high water pressure is acting on fourth segment 2117 of elastomeric member 21444 from its other first side).

Any professional in the field will understand that this combination provide for a diaphragm or shutter based pressure regulation mechanism—fourth segment 2117 of elastomeric member 21444 acting as a diaphragm over slit 2133 while elastically bending toward or away from slit 2133 (while the slit preventing a complete shutdown of the flow), in accordance with the differential water pressure prevail on both sides of fourth segment 2117 (see FIGS. 21a and 21b).

The pressure regulated water passing through slit 2133 are then routed by flow channel 2135 into embedded chamber 21468 which constitute part of the water-accumulation chamber of drip emitter 2110.

FIG. 22 is a schematic drawing of drip emitter 2110 illustrated in FIG. 21, in a way that clarifies that its structure is consistent with the aspects of an example of any drip emitter in accordance with the invention, as illustrated in FIG. 20. In light of the description and the above references to FIGS. 4-21 (and especially in comparison to FIG. 11), any skilled person will be able to deduce the specific components of drip emitter 2110 upon mounting its three members—housing member 21440, cover member 21442 and elastomeric member 21444 to each other, with the schematic drawing of an example of any drip emitter according to the invention, as illustrated in FIG. 20.

It was found that in a given geometrical (dimensional) constrains of a tri-part, discrete, rectangular shaped, integral drip emitter, implementing a second pressure-reducing mechanism in accordance with the mechanism described above while referring to FIGS. 20-21 (namely a combination of a baffle labyrinth followed in arrow by a diaphragm based, pressure regulating shutter), reduced the flow rate into the drip emitter water accumulating chamber, by 4-6 times in comparison to similar dripper implementing a second pressure-reducing mechanism in accordance with the mechanism described above while referring to FIGS. 4-19 (namely a baffle labyrinth per-se), and as a direct consequence—prolonging by 4-6 times the drip period and the quantities of the water dripped (the dose) before closing of the dripper outlet took place.

Any professional in the art will appreciate that the elastomeric based mechanism also enable a flushing of the mechanism upon closing and re-opening of the emitter for irrigation. In addition, any professional will understand that other types of diaphragm based pressure regulating (throttling) means that are known in the art of drip emitters design, may be implemented in order to reduce the water flow rate in the second pressure-reducing mechanism of a drip emitter for periodic, volumetrically-timed irrigation in accordance with the invention (e.g.—pressure regulating elastomeric labyrinth, regulating by deforming a diaphragm over a labyrinth). Alternative pressure-reducing mechanisms that as said, are known to every person skilled in the art of drip emitters design.

Therefore, in light of the description given above with reference made to the accompanying drawings, a person skilled in the art would appreciate that the Patent Applicant discloses an improved design of a drip emitter that implements a “capacitor” mechanism or hydro-mechanical timer that the Applicant was the first to introduce, thereby enabling the economical manufacture of the drip emitter (despite the added mechanism), and ensuring stable closure of the flow from the drip emitter and efficient discharge of the water accumulated inside, from the time the flow passage from it is re-opened, to the area designated for irrigation.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from the proper construction of the appended claims, and their equivalents.

1. A drip emitter for periodic, volumetrically-timed irrigation, comprising:
a water inlet to the drip emitter, a water outlet from the drip emitter, and an irrigation water flow path disposed between the water inlet and the water outlet, the irrigation water flow path including a first pressure-reducing mechanism configured to convert the water flow entering the drip emitter from the water inlet under pressure into drops dripping from the water outlet; and
a water-accumulation chamber separating the downstream side of said first pressure-reducing mechanism from the water outlet of the drip emitter, and connected to the water inlet through an accumulatable water flow path having a second pressure-reducing mechanism, wherein said water-accumulation chamber also contains an elastic member separating and dividing between the accumulatable water on one side and the irrigation water on the other;
whereby when water accumulates on the one side of the elastic member that faces the accumulatable water flow path, the elastic member is stressed for strain and bends towards the irrigation water outlet from the drip emitter, so that eventually the other side of the elastic member comes in contact with the water outlet from the drip emitter and closes the water outlet; and
whereby when the pressure of the water entering the drip emitter is reduced, the water-accumulation chamber empties of the water accumulated inside, the elastic member is no longer stressed for strain, and the elastic member returns to a starting state by distancing the other side of the elastic member from the water outlet of the drip emitter and consequently opening the water outlet; and
wherein the drip emitter also comprises:
a first no-drain valve positioned after the irrigation water inlet and before the irrigation water flow path and the accumulatable water flow path, and configured to allow for a parallel flow of water towards the irrigation water flow path and the accumulatable water flow path when the valve is opened, and to close under predetermined pressure;
a second valve located on the downstream side of said first pressure-reducing mechanism of the irrigation water flow path in the drip emitter, positioned before the water-accumulation chamber that separates the downstream side of said first pressure-reducing mechanism from the water outlet of the drip emitter, and configured to allow the passage of irrigation water through the water-accumulation chamber on the other side of the elastic member to the water outlet when the second valve is open and to close under predetermined pressure; and
a water drain connected to the flow of irrigation water from the other side of the elastic member in the water-accumulation chamber and configured to direct irrigation water to said second valve, in a manner that helps to close the second valve.

2. The drip emitter according to claim 1, wherein said second valve will open and allow the passage of irrigation water through the water-accumulation chamber, on the other side of the elastic member, to the water outlet when the pressure of the irrigation water on the downstream side of said first pressure-reducing mechanism is lower than the predetermined water pressure.

3. The drip emitter according to claim 1, wherein said first pressure-reducing mechanism is designed to provide less resistance to the irrigation water flow than the resistance the said second pressure-reducing mechanism provides to the accumulatable water flow, thereby ensuring a period of time when irrigation water flows from the drip emitter to the designated irrigation area, even before a volume of accumulatable water accumulates in said water-accumulation chamber that will cause the said water outlet to close.

4. The drip emitter according to claim 1, wherein said first no-drain valve comprises an elastomeric diaphragm member, one side of which is exposed to the pressure of the water entering from said water inlet, and a second side comprises an air draining means that exposes said second side to atmospheric pressure.

5. (canceled)

6. The drip emitter according to claim 1, wherein said drip emitter is an integral drip emitter that is formed as a sort of rectangular prism and is configured to be affixed to the inner wall of a water conduit, and wherein said drip emitter is also characterized in that it is a tri-part drip emitter comprised of a housing member, a cover member configured to fit inside said housing member, and an elastomeric member that is configured to fit between the housing member and the cover member.

7. The drip emitter according to claim 6, wherein said elastomeric member is an integral unified part that is formed with a first segment that serves as an elastomeric diaphragm in said first no-drain valve, with a second segment that serves as an elastomeric diaphragm in said second valve, and with a third segment that serves as an elastomeric diaphragm in said elastic member.

8. The drip emitter according to claim 7, wherein said integral unified elastomeric member is formed as a rectangular flat surface, with said first and second segments arranged side by side on the rectangular flat surface, each having a round configuration, and said third segment is arranged next to the first and second segments on the rectangular flat surface in a rectangular configuration.

9. The drip emitter according to claim 7, wherein upon assembling said cover member inside said housing member, said first, second and third segments of said elastomeric member are each circumferentially harnessed in order to operate them as elastic diaphragms, by arrays of matching protrusions and channels formed in said elastomeric member and in said housing member or said cover member.

10. The drip emitter of claim 7, wherein upon assembling said cover member inside said housing member, said first, second and third segments of said elastomeric member are each circumferentially harnessed in order to operate them as elastic diaphragms, by flat flange means.

11. The drip emitter of claim 7, wherein
said housing member is shaped like a rectangular box that is open at the top and comprises: said water inlet, a stem that protrudes from the interior surface of the bottom of the housing member, while the housing member is connected to the water flow from said water inlet and is formed with a circumferential rim that serves with said first segment of said elastomeric member as a sealing base for said first no-drain valve; a segment of said second pressure-reducing mechanism that is formed as a two-ended baffle labyrinth, which is embedded into the interior surface of the bottom of the housing member; an embedded chamber that is formed in the interior surface of the bottom of the housing member and is connected to a flow of water into it from a second end of said baffle labyrinth; and another embedded chamber;
said cover member is shaped like a rectangular prism, wherein upon mounting the drip emitter meant to be affixed to the inner wall of a feeding pipe, one side is formed: with an embedded exit pool, the bottom of which is formed as a wall in the center of which is an opening that is used as an irrigation water outlet from the drip emitter; with said first irrigation water pressure-reducing mechanism, which is formed as an embedded two-ended baffle labyrinth, which is connected from its second end to the water flow through an opening to the second side of the cover member; with an embedded two-ended channel, which extends along the cover member parallel to said baffle labyrinth, wherein it is connected at its second end to an air drain to the exit pool; and with a chamber that is connected to the flow of irrigation water through it from the second side of the cover member through one opening and for the outflow of the water back to the second side of the cover member through a second opening;
said cover member is formed on its second side, which upon mounting the cover member inside said housing member, faces the interior surface of the bottom of the housing member; with an embedded chamber that is demarcated by the bottom of said exit pool and is formed with a water outlet opening from the drip emitter in the center of the chamber and with said one opening that is connected to the irrigation water passage to the chamber on the other side, formed on the side of the chamber; with a stem that protrudes from the surface of the second side of the cover member, wherein it is connected to the irrigation water passage from said first pressure-reducing mechanism and is formed with a circumferential rim that serves together with said second segment of the elastomeric member as sealing base for said second valve; with an embedded passage that connects to the irrigation water passage from said stem to said embedded chamber that is demarcated at the bottom of said exit pool, and through the water outlet opening from the drip emitter to the exit pool; with another segment of said second pressure-reducing mechanism that is formed as a two-end baffle labyrinth; and with an embedded chamber where an air drain opening is formed at the bottom of it and is connected for draining air to one side of the cover member, to one end of the embedded channel which, as said, spans the length of the cover member, wherein it is connected from its second end for draining air into the exit pool; and
said elastomeric member is formed as a rectangular flat surface, which in addition to said first, second and third segments, which upon assembling the drip emitter serves as elastic diaphragms, respectively, of said first no-drain valve, of said second valve and of said elastic member, is also formed with a plurality of through-flow openings, the plurality of through-flow openings comprising: an opening that is connected to irrigation water flow to the one end of the baffle labyrinth, which serves as said first pressure-reducing mechanism and is formed in said cover member; an opening that is connected to accumulatable water flow to one end of the baffle labyrinth segment which serves as the second pressure-reducing mechanism and is formed in said cover member; an opening that connects to the accumulatable water passage from the second end of the baffle labyrinth segment that serves as the second pressure-reducing mechanism and is formed in said housing member; and an opening that connects to the irrigation water flow from the second opening of the chamber, which is formed on the one side of the cover member, to the additional embedded chamber that is formed on the interior surface of said housing member.

12. The drip emitter of claim 6, wherein said cover member is fitted inside said housing member by snap-fit connectors formed between the cover member and the housing member.

13. The drip emitter according to claim 1, wherein
said drip emitter is an integral drip emitter that is formed as a sort of rectangular prism and is configured for affixing to the inner wall of a water conduit; and,
the drip emitter is a two-part manufacture, bi-component that comprises a housing member, a frame that is formed with an elastomeric member within the frame and is connected to said housing member by an integral hinge, and a cover member.

14. The emitter according to claim 1, wherein
said drip emitter is an integral drip emitter that is formed as a sort of rectangular prism and is configured to be affixed to the inner wall of a water conduit; and
the drip emitter is a one-part manufacture, bi-component that comprises a housing member, a frame member that is formed with an elastomeric member within the frame and is connected to the housing member by one integral hinge, and a cover member, which is connected to said housing member by a second integral hinge.

15. The emitter according to claim 1, wherein said second pressure-reducing mechanism comprises a baffle labyrinth or a diaphragm based, pressure regulating shutter or a combination of both.

16. The drip emitter according to claim 15, wherein:
said drip emitter is an integral drip emitter that is formed as a sort of rectangular prism and is configured to be affixed to the inner wall of a water conduit; and
said drip emitter is also characterized in that it is a tri-part drip emitter comprised of a housing member, a cover member configured to fit inside said housing member, and an elastomeric member that is configured to fit between the housing member and the cover member.

17. The drip emitter according to claim 16, wherein said elastomeric member is an integral unified part that is formed with a first segment that serves as an elastomeric diaphragm in said first no-drain valve, with a second segment that serves as an elastomeric diaphragm in said second valve, with a third segment that serves as an elastomeric diaphragm in said elastic member, and with a fourth segment that serves as an elastomeric diaphragm in said pressure regulating shutter.

18. (canceled)

19. A drip emitter for periodic, volumetrically-timed irrigation, comprising:
a water inlet to the drip emitter, a water outlet from the drip emitter, and an irrigation water flow path disposed between the water inlet and the water outlet, the irrigation water flow path including a first pressure-reducing mechanism configured to convert the water flow entering the drip emitter from the water inlet under pressure into drops dripping from the water outlet; and
a water-accumulation chamber separating the downstream side of said first pressure-reducing mechanism from the water outlet, and connected to the water inlet through an accumulatable water flow path having a second pressure-reducing mechanism, wherein said water-accumulation chamber also contains an elastic member separating and dividing between the accumulatable water on one side and the irrigation water on the other;
whereby when water accumulates on the one side of the elastic member that faces the accumulatable water flow path, the elastic member is stressed for strain and bends towards the irrigation water outlet from the drip emitter, so that eventually the other side of the elastic member comes in contact with the water outlet from the drip emitter and closes the water outlet; and
whereby when the pressure of the water entering the drip emitter is reduced, the water-accumulation chamber empties of the water accumulated inside, the elastic member is no longer stressed for strain, and the elastic member returns to a starting state by distancing the other side of the elastic member from the water outlet of the drip emitter and consequently opening the water outlet.

20. The drip emitter according to claim 19, further comprising a first no-drain valve positioned after the irrigation water inlet and before the irrigation water flow path and the accumulatable water flow path, and configured to allow for a parallel flow of water towards the irrigation water flow path and the accumulatable water flow path when the valve is opened, and to close under predetermined pressure.

21. The drip emitter for periodic, volumetrically-timed irrigation, comprising:
a water inlet to the drip emitter, a water outlet from the drip emitter, and an irrigation water flow path disposed between the water inlet and the water outlet, the irrigation water flow path including a first pressure-reducing mechanism configured to convert the water flow entering the drip emitter from the water inlet under pressure into drops dripping from the water outlet;
a water-accumulation chamber separating the downstream side of said first pressure-reducing mechanism from the water outlet, and connected to the water inlet through an accumulatable water flow path having a second pressure-reducing mechanism, wherein said water-accumulation chamber also contains an elastic member separating and dividing between the accumulatable water on one side and the irrigation water on the other; and
a second valve located on the downstream side of said first pressure-reducing mechanism of the irrigation water flow path in the drip emitter, positioned before the water-accumulation chamber that separates the downstream side of said first pressure-reducing mechanism from the water outlet, and configured to allow the passage of irrigation water through the water-accumulation chamber on the other side of the elastic member to the water outlet when the second valve is open and to close under predetermined pressure;
whereby when water accumulates on the one side of the elastic member that faces the accumulatable water flow path, the elastic member is stressed for strain and bends towards the irrigation water outlet from the drip emitter, so that eventually the other side of the elastic member comes in contact with the water outlet from the drip emitter and closes the water outlet; and
whereby when the pressure of the water entering the drip emitter is reduced, the water-accumulation chamber empties of the water accumulated inside, the elastic member is no longer stressed for strain, and the elastic member returns to a starting state by distancing the other side of the elastic member from the water outlet of the drip emitter and consequently opening the water outlet.

22. The drip emitter according to claim 21, further comprising a water drain connected to the flow of irrigation water from the other side of the elastic member in the water-accumulation chamber and configured to direct irrigation water to said second valve, in a manner that helps to close the second valve.
